(19) United States
(12) Patent Application Publication
(10) Pub. No.: US 2007/0295667 A1
(43) Pub. Date: Dec. 27, 2007

(54) Water filter apparatus and methodology

(76) Inventor: John C. Ruprecht, North Oaks, MN (US)

Correspondence Address: JAMES D. WELCH, 10328 PINEHURST AVE., OMAHA, NE, 68124, US

(21) Appl. No.: 11/724,883

(22) Filed: Mar. 16, 2007

Related U.S. Application Data
(63) Continuation-in-part of application No. 11/334,787, filed on Jan. 19, 2006.
(63) Continuation-in-part of application No. 11/452,012, filed on Jun. 14, 2006.
(63) Continuation-in-part of application No. 11/452,013, filed on Jun. 14, 2006.

(51) Int. Cl. C02F 1/00; B01D 21/30; B01D 27/02; C02F 1/50; C02F 9/00; C02F 1/68; C02F 1/28; B01D 35/30

(52) U.S. Cl. 210/693; 210/146; 210/234; 210/256; 210/282; 210/455; 210/501; 210/692; 210/764

(57) ABSTRACT

Water filters systems for providing potable water including a combination of ceramic with anti-microbial embedded therewithin, and granular activated charcoal.

This application is a CIP of Utility application Ser. Nos. 11/334,787 Filed Jan. 19, 2006; 11/452,012 Filed Jun. 14, 2006; and 11/452,013 Filed Jun. 14, 2006; and therevia Claims benefit Provisional Application Ser. Nos. 60/694,092 Filed Jun. 27, 2005; 60/694,093 Filed Jun. 27, 2005; and No. 60/614,142 Filed Sep. 29, 2004.

### TECHNICAL FIELD

The present invention relates to water filter systems and more particularly to water filtering systems that provide potable water.

### BACKGROUND

The present invention comprises water filter systems which include ceramics with embedded anti-microbial, and granular activated charcoal.

Prior disclosure in Pending Parent Applications describe:
a filter system comprising a combination manifold and single lever quarter-turn system to which a filter module removably attaches, thereby facilitating changing said removably attachable filter modules;
a floor mountable whole house water filter which does not develop significant back pressure because water enters via a perforated distribution tube inlet, then flows down said perforated distribution tube and exits radially outward through activated carbon or a ceramic filter, before exiting via an output means in an outer housing thereof;
a system for entering a mixture of oil and water thereinto which develops a high back pressure, and via causing said mixture to pass through a mixture of polypropylene and plastic beads in an upper majority thereof, and polypropylene in the lower minority thereof, providing water at an outlet from which the oil has been removed.

### Local Filter

As regards the first embodiment, it is disclosed that common practice when installing a manifold to which a replaceable fluid filter module attaches, to also install separate valves ahead of, and usually after, said manifold. This is to enable changing the filter module without disrupting fluid to other locations in a service system. In use, when it is necessary to change a filter module which is secured to the manifold, the separate valves are first shut off, and then the manifold is operated to release the filter module. A new filter module is then put into place and the manifold operated to secure it, followed by reopening the separate valves ahead of and after said manifold. This is tedious.

A Search of patents provided a number of patents, of which the most relevant is believed to be No. 6,645,376 to Marioni. The system of the 376 patent provides a lever (33) which provides fluid flow control, however, filter removal and installation requires separate action. A patent to Knuth, No. 3,399,776 describes a detachable filter system which allows for removal of a filter without interruption of fluid flow, which is directed through a bypass. U.S. Pat. No. 5,486,288 provides a system for allowing removal and replacement of a filter cartridge by a rotation motion thereof. Said system does not comprise a lever control however. U.S. Pat. No. 5,107,896 to Otto has a lever, but it only operates the inlet side to effect bypass, shut-off and in-service capability. U.S. Pat. No. 4,877,521 to Petrucci et al. provides a system that allows a canister to be rotated Into place in a head by a ¼ turn, but does not involve lever control. U.S. Pat. No. 3,746,171 describes a filter assembly with a lever that rotates vertically about a horizontally oriented axis, rather than in a horizontally oriented direction about a vertically oriented axis. U.S. Pat. No. 3,907,688 to Close describes a valve for a filter involving a lever which controls fluid directing, however, operation of the lever does not simultaneously control the attachment or release of a filter cartridge, which is attached by a hinged band. U.S. Pat. No. 4,857,189 to Thomsen et al. was also identified, but is not believed to be particularly relevant.

### Whole House Filter

As regards the second embodiment, it is disclosed that it is know to use filters to remove particulates from water. A problem with many such filters, however, is that they cause significant back pressure to develop, and where a filter is to be applied to filter water which enters a house it is important that back pressure not develop, as back pressure reduces in-house water pressure. The present invention is a filter system which does not develop significant back pressure in use.

With the present invention in mind, a Search of patents was conducted and identified:
Published Application US 2004/0154976 and U.S. Pat. No. 6,827,852 to Fuentes discloses a filter housing assembly containing a filter bag;
U.S. Pat. No. 5,910,247 to Outterside describes a two element filter bag, a cylinder outer element and tubular inner element. It is not of a single bag filter or single ceramic filter design, with in flow and out flow being through activated carbon, and there are tubular inner elements present, as that terminology is used in said 247 patent;
U.S. Pat. No. 5,624,559 to Levin et al. describes a bag filter and retainer therefore;
U.S. Pat. No. 5,591,338 to Pruette et al. describes a fluid filter with tubular core surrounded by wire cage around which is a pleated bag, and is not of an all-resin construction;
U.S. Pat. No. 4,913,815 to Shulda describes a concentric dual bag filter with contained media. The Dual bag filter apparatus has an inlet, outlet, outer and inner bag, filter medium within the outer bag and a perforated tube in the inner bag. The 815 system has multiple bags, and does not have a filter held in place by a reusable slotted colander, and does not have a filter housing made of resin with a fitted slotted colander, which is also made of resin;
U.S. Pat. No. 5,514,275 Wall filter unit with filter bag supported within a chamber. The present invention is a floor mounted unit as its size and filtering capability precludes it from being wall mounted;
U.S. Pat. No. 5,006,245 describes a water purifying device with an outer and inner cylinder filled with water purifying material. However, the major components are not made from resin with no metal in either the inner or outer cylinders;
U.S. Pat. No. 5,376,271 to Morgan, Jr. describes a liquid filtration unit with a filter basket containing a filter bag;
U.S. Pat. No. 4,652,369 to DePolo et al. describes a filtering system for swimming pools and has cylinder a porous filter bag with a center tube.

### Oil/Water Separator

As regards the third embodiment, it is disclosed that it is known to remove oil from liquids such as water using filtering means.

With the present invention in mind, a Search of patents was conducted and identified:
U.S. Pat. No. 6,015,494 to Siverling et al. describes a oil/water separator using a polyolefin sheets;
U.S. Pat. No. 4,913,815 to Shulda describes a concentric dual bag filer having an inlet and outlet, and polypropylene filter means in a dual bag;
U.S. Pat. No. 4,839,040 to Alm describes a filter apparatus for purifying oil contaminated water that has cylindrical outer and inner shells;
U.S. Pat. No. 4,282,097 to Kuepper et al., describes a method of separating oil and water through coalescer tubes made from water permeable fibers. Use of polypropylene is mentioned;
U.S. Pat. No. 3,830,371 to Garcia describes using polypropylene in an apparatus for separating oil and water by passage through a cylindrical shaped space;
U.S. Pat. No. 3,617,548 to Willihnganz describes a method for separating oil and water by passage through a polypropylene mesh. The discussion regarding the 371 patent is generally applicable;
Patent RE 31,047 to Ross describes a method for separating oil from water by passage through a fiber web involving use of polypropylene;
U.S. Pat. No. 5,948,253 to Hearn describes a filter for removal of hydrocarbons and synthetic hydrocarbons from water, having three layers of filtering.

### Sequential Ceramic-Activated Granular Charcoal Filters

The present invention comprises a combination of separate and merged ceramic with embedded anti-microbial, and activated charcoal, in functional combination with any of the foregoing embodiments. As such, a Search for patents that disclose such a combination of components in a water filtering system was conducted. The results provided:
U.S. Pat. No. 7,090,779 to Bernstein et al., which discloses that there are portable devices that combine activated charcoal and a ceramic filter.

U.S. Pat. Nos. 5,868,933 and 5,762,797 to Patrick et al., which disclose an antimicrobial filter comprising microporous membranes.
U.S. Pat. No. 7,189,330 to Hayashi et al. describes a method of producing hydrogen rich water.
U.S. Pat. No. 7,172,695 to Kato et al., describes a liquid treating tank and filtering unit comprising an anti-microbial filtering layer.
U.S. Pat. No. 5,064,534 to Busch et al. describes a tap water purification filter.
U.S. Pat. No. 5,342,528 to Adachi et al. describes a water purifying material comprising charcoal and silver.
U.S. Pat. No. 5,714,065 to Huder describes a fluid filter.
U.S. Pat. No. 6,013,181 to Thellmann describes a water filter comprising charcoal granules.
U.S. Pat. No. 6,524,477 to Hughes describes a filter cartridge for removal of microorganisms.
U.S. Pat. No. 7,077,272 to Shimada describes an antibacterial filter.
U.S. Pat. No. 7,014,782 to D'Emidio et al. describes a point of use filter.
Published Patent Application US 2006/0266691 by Cheng describes a system comprising ceramic, KDF, copper zinc etc.

Need remains for water filter systems which comprise ceramic with embedded anti-microbial(s), and in addition, granular activated charcoal.

### DISCLOSURE OF THE INVENTION

To begin, it is disclosed that the present invention is, in one respect, found in the presence of ceramic with anti-microbial embedded therewithin, and granular activated charcoal, in water filter systems which provide potable water at an output thereof.

To aid in understanding, previous disclosure in Pending Parent patent applications is repeated herein, with some amendment, to provide insight as to systems to which the present invention can be applied. One such system is a local filter comprising a combination manifold and single lever cantered element system to which a filter module removably attaches. A ¼ rotation of the single lever mediates simultaneous operation of both valving and filter module release, and facilitates changing removably attachable filter modules without the need for tools. A second thereof is a floor mountable whole house water filter which does not develop significant back pressure in use because water enters via a perforated tube inlet, then flows down said perforated tube and exits radially outward through activated carbon or a ceramic filter toward a larger area, before exiting via an output port in an outer housing thereof. And the third thereof is another floor mountable system which is designed to allow entering of a mixture of non-water component(s), (eg. oil), and water thereinto and which develops a high back pressure, and via causing said mixture to pass through a mixture of polypropylene and plastic beads in an upper approximately ⅔ thereof, and polypropylene in the lower approximately ⅓ thereof, providing water at an outlet from which the non-water component(s) has been removed. It is to be understood that while preferred locations for the ceramic with anti-microbial embedded therewithin, and granular activated charcoal in said systems, will be pointed out, said ceramic with anti-microbial embedded therewithin, and granular activated charcoal can be placed at any functional locations therein.

### Local Filter

Continuing, in more detail, Pending application Ser. No. 11/334,787 Filed Jan. 19, 2006 discloses a system comprising a manifold and cantered element which comprises a single lever that is required to rotate only ¼ of a turn to, substantially simultaneously, shut-off inlet and outlet fluid supplies, and allow dropping a filter module, which filter module presents with dynamic fluid pressure, therefrom. Likewise, when the single lever is rotated ¼ of a turn in an opposite direction, a new filter can be drawn into an operational position and, substantially simultaneously, the inlet and outlet fluid supplies are re-opened. No tools are required, and the system design and simple operation thereof makes mis-installation of a filter module essentially impossible. The multi-tasking manifold/single lever combination then performs in a single operation what other known systems require two actions to accomplish. The filter module is designed so that the inlet and outlets thereof can only match to the inlet and outlets of the manifold, thereby preventing backward installation.

Said invention then comprises a combination manifold and valve system to which a filter module removably attaches. Said combination manifold and valve system is constructed such that when the manifold is operated to allow affixing a filter module the valve(s) in the manifold are caused to be closed, and when the manifold is operated to securely affix a filter module thereto, the valve(s) in the manifold are caused to be open. The system is characterized in that a single lever which rotates no more than ¼ turn, completely and substantially simultaneously controls both the valves and filter module mounting.

The filter module removably attaches and is held in place by means for securing said filter module and said combination manifold and valve system comprises a manifold central structural element with two ports to which fluid carrying pipes affix, each of said ports having fluid carrying piping projecting therefrom into a filter module which is secured in place on said manifold, by said means for securing said filter module. Said combination manifold and valve system has affixed thereto means simultaneously operating said valves and means for securing said filter module to said manifold, such that when a filter module is secured in place on said manifold by said means for securing said filter module, said valves are open, and when said filter module is not secured in place on said manifold, said valves are closed.

A mechanism for controlling the securing of said filter module to said manifold comprises a single lever of a cantered element which is rotatable affixed to the top of said manifold central structural element, as it is viewed in side elevation, such that when said lever of said cantered element is rotated in one direction the means for securing said filter module are caused to rise, and when said single lever of said cantered element is rotated in the opposite direction said means for securing said filter module are caused to lower.

The preferred filter module has a lip at an upper aspect thereof, and said means for securing said filter module has hook-like structures which can catch said lip. Said means for securing said filter module additionally has an elongated slit therein into which projects a rod which is secured stationary with respect to said manifold central structural element.

An alternative recitation of the said invention combination manifold and valve system provides that it comprises:

a central structural element which has a substantially closed top and sides, said sides having first and second openings therein, each of which is suitable for attaching thereto a fluid carrying pipe, said central structural element having therewithin a substantially circular inner cavity;

there being, during use, a filter module comprising filter media therewithin, secured to the lower extent of said central structural element as viewed in side elevation;

present in said substantially circular inner cavity there being snuggly present a rotatable structural element having a top and a side wall, said rotatable structural element having first and second openings in said wall, which openings are functionally projected inwardly and then downward in the form of unequal lengths of pipe-like elements such that fluid entered into one thereof passes through said filter module which is affixed to the lower aspect of said combination manifold and valve system and out of the other thereof;

said first and second openings in said central structural element and said first and second openings in said rotatable structural element wall being arranged with respect to one another such that when the first of the openings in said central structural element and the first of said openings in said rotatable structural element wall are aligned by relative rotation therebetween, then simultaneously so are the second openings in the central structural element and said second opening is said rotatable structural element wall;

there being a rotatably mounted single lever of said cantered element at the top of said central structural element, and there being means for securing said filter module slidably affixed to the sides of said central structural element, said cantered element and means for securing said filter module being functionally interrelated such that causing said single lever of said cantered element to rotate about a substantially vertically oriented axis causes said means for securing said filter module to slide with respect to said central structural element;

said means for securing said filter module having hook-like structures at lower aspects thereof and a slit shaped opening thereabove, into which slit shaped opening projects a rod which is secured stationary with respect to said central structural element;

said combination manifold and valve system filter module further comprising a lip at an upper extent thereof, which hook-like structures are of a shape to catch.

The slit shaped openings in the means for securing said filter module having hook-like structures at lower aspects thereof is elongated and can be oriented such that its elongated dimension projects substantially vertically, as viewed in side elevation, or said slit shaped opening can be oriented such that its elongated dimension projects at an angle between vertical and horizontal, again as viewed in side elevation. The later configuration is preferred.

The filter module preferably comprises, as viewed in side elevation, receptors in an outer covering thereof which have a vertical and a horizontal section such that each forms an “L” shape. Said filter module then further comprises a filter lid which attaches to said filter module outer covering by way of sliding nibs on said filter lid into the vertical portions of said receptors on said filter module outer covering, and then causing a slight rotation motion of filter lid so that nibs are positioned in the horizontal portions of said receptor portions. In use rotating said filter lid so that said nibs thereon are in the vertical sections of the receptors in the filter module outer covering allows entering and removing the filter lid, and rotating said filter lid so that the nibs are in the horizontal portions of the “L” shaped receptors secures said lid in place in the filter module.

A method of filtering fluid comprising the steps of:

a) providing a combination manifold and valve system comprising:
a central structural element which has substantially closed top and sides, said sides having first and second openings therein, each of which is suitable for attaching thereto a fluid carrying pipe, said central structural element having therewithin a substantially circular inner cavity;
there being, during use, a filter module comprising filter media therewithin, secured to the lower extent of said outer cover;
present in said substantially circular inner cavity there being snuggly present a rotatable structural element having a top and wall, said rotatable structural element having first and second openings in said wall, which openings are functionally projected inwardly and then downward in the form of unequal lengths of pipe-like elements such that fluid entered into one thereof passes through said filter module which is affixed to the lower aspect of said combination manifold and valve system and out of the other thereof;
said first and second openings in said central structural element and said first and second openings in said rotatable structural element wall being arranged with respect to one another such that when the first of the openings in said central structural element and the first of said openings in said rotatable structural element wall are aligned by relative rotation therebetween, then simultaneously so are the second openings in the central structural element and said second opening is said rotatable structural element wall;
there being a rotatably mounted single lever of a cantered element at the top of said central structural element, and there being means for securing said filter module slidably affixed to the sides of said central structural element, said means for securing said filter module and said central structural element being functionally interrelated such that causing said single lever of said cantered element to rotate about a substantially vertical axis, causes said means for securing said filter module to slide with respect to said central structural element;
said means for securing said filter module having hook-like structures at lower aspects thereof and said filter module further comprising a lip at an upper extent thereof, which hook-like structures are of a shape to catch said lip;

b) with fluid pressure absent affixing fluid carrying pipes to said first and second openings of said outer cover, rotating said rotatably mounted single lever of said cantered element at the top of said central structural element so that the first and second holes in said central structural element and said first and second holes in said rotatable structural element wall are not aligned and so said means for securing said filter module having hook-like structures at lower aspects thereof are lowered;

c) entering a filter module such that the lip at said upper extent thereof is grasped by said hook-like structures of said means for securing said filter module;

d) rotating said rotatably mounted single lever of said cantered element at the top of said outer cover so that the first and second holes in said central structural element and said first and second holes in said rotatable structural element wall are aligned and so said means for securing said filter module having hook-like structures at lower aspects thereof are raised to secure said filter module to said combination manifold and valve system; and

e) pressurizing said fluid in said fluid carrying pipes which are affixed to said first and second openings of said central structural element.

Said method can further comprise the steps of:

f) rotating said rotatably mounted single lever of said cantered element at the top of said central structural element so that the first and second holes in said central structural element and said first and second holes in said rotatable structural element wall are not aligned and so said means for securing said filter module having hook-like structures at lower aspects thereof are lowered;

g) removing said filter module and replacing it with a new filter module or replacing the filtering media therein, such that the upper lip of said new filter module or filter module with replaced filtering media therein is grasped by said hook-like structures of said means for securing said filter module; and

h) rotating said rotatably mounted single lever of said cantered element at the top of said central structural element so that the first and second holes in said central structural element and said first and second holes in said rotatable structural element wall are aligned and so said means for securing said filter module having hook-like structures at lower aspects thereof are raised to secure said filter module to said combination manifold and valve system.

As alluded to, said method of filtering fluid can involve, in step g, replacing filtering media in the filter module. In such a case the filter module can comprise, as viewed in side elevation, receptors in an outer covering thereof which have a vertical and a horizontal section such that each forms an “L” shape. Said filter module then further comprises a filter lid which attaches to said filter module outer covering by way of sliding nibs on said filter lid into the vertical portions of said receptors on said filter module outer covering, and then causing a slight rotation motion of filter lid so that nibs are positioned in the horizontal portions of said receptor portions. When this is the case, the step of replacing said filtering media comprises:

g1) rotating said filter lid so that said nibs thereon are in the vertical sections of the receptors in the filter module outer covering;

g2) removing said filter lid from said filter module by moving it in a direction defined by the locus of said vertical portions of said receptors;

g3) removing old filtering media from said filter module and placing new filtering media thereinto;

g4) positioning said filter lid such that nibs thereon align with vertical portions of the receptors in said filter module outer covering and causing said filter lid to move toward said filter module outer covering in a direction defined by the locus of said vertical portions of said receptors;

g5) causing said filter lid to rotate so that the nibs thereon are caused to be placed into the horizontally oriented portions of said “L” shaped receptors.

### Whole House Filter

Continuing, in more detail, Pending application Ser. No. 11/452,013 Filed Jun. 14, 2006 discloses a system comprising a floor mountable whole house water filter which because of its design does not develop significant back pressure to water entered thereinto. This is because water flow is completely or at least predominately outward through filtering means, from a small area toward a large area. To achieve this result, the said invention system can comprise a housing with an inner colander that is slotted, and have a bag filter which contains filler material, or a ceramic filter, fitted into said slotted inner colander. A perforated tube that is capped on the bottom end is centered in the bag filter, and activated carbon is caused to be present in said bag filter with the centered perforated tube positioned in the center thereof. Said perforated tube serves to distribute water input thereto into the filter activated carbon along the length thereof. With a bag filter full of activated carbon or a ceramic filter in place, a top cap with centering tube is placed over the slotted colander and the center tube top cap is then secured thereto. The slotted colander is lowered into the filter housing, and the filter element seals against an “O”-ring that is present around the outside of slotted colander in a groove designed therefore. The “O”-ring is located near the top of the colander and seals the colander/filter element against the filter housing to prevent water migration around the filter element to the discharge. Water enters the top of the filter element via the perforated tube, and said inlet water flows down the perforated tube, and exits therefrom radially outward through the activated carbon, then out of the bag filter through the slotted colander to discharge of the filter outer housing. As mentioned, this design results in next to no water pressure drop through the described filter, utilization of the entire carbon bed, and easy change out of the filter element when required. The user then, never comes in contact with the captured hazardous waste.

The said invention system can also comprise an embodiment which is very similar to that just described above, but instead of having a bag filter, has a ceramic filter having, for instance, a 99.99% efficiency at 0.9-microns. Note that said ceramic filter has been third party tested to remove E. Coli and is efficient at removing particulates to 0.4 microns at 99.6%. Said ceramic filter has, for instance, 0.05% silver embedded in the ceramic, and the silver prevents captured bacteria from breeding or growing therein and is a self sanitizing agent. It is disclosed that testing of the said invention was performed on Apr. 22, 2005 by Analytical Food Laboratories, 856 Greenview Drive, Grand Prairie, Tex. Said Testing facility certified that the said invention Ceramic water filter element was tested for bacteriological removal capacity and showed greater than 99.99% removal efficiency at 0.9 microns. The test method consists of growing cultures of E. coli then diluting them into tap water to give the concentration required for test. Normally, a concentration between 10 to the 4 and 10 to the 5 colony forming units (CFU) per ml are used as the influent water level to the filter, and the removal efficiency is tested at a flow rate of 300 liters per hour and 90 liters per hour, using separate filters or sterilizing between tests. Preferably sterilization is done prior to the test as well. The level of E. Coli in the influent and effluent water is measured on each test run. The challenge water was inoculated with live culture of E. Coli (generic) of a known concentration. The water was then filtered through the provided apparatus and samples were taken at the beginning, middle and end. Typical growth was recovered in the filtered water but at lower levels indicating the filter was able to block passage of the specific bacteria. The data provided is:
Initial Concentration: 5.7×10⁸ Inoculum was diluted to 30,000 cfu/mL and placed in the apparatus. From the apparatus, aseptic samples were pulled at the beginning of the filtering, middle of the filtering and end of the filtering. The samples were then tested using methods from BAM Ch4.
Recovery of the bacteria at levels of 0.6% or a filtering percentage of 99.4% indicates that the filter provided blockage of the bacteria.

Continuing, the ceramic filter is cast to fit inside the slotted colander, the top of the ceramic filter is sealed to the slotted colander preventing non-filtered water migrating around the ceramic filter to discharge. The cast ceramic filter is fitted into the slotted colander a perforated tube that is capped on the bottom end is then centered in the ceramic filter, activated carbon is caused to be present in the ceramic filter with the centered perforated tube positioned in the center. With the ceramic filter full of activated carbon a top cap with centering tube is placed over the slotted colander and center tube this top cap is then secured to the slotted colander. The slotted colander is lowered into the filter housing placing the filter element against a sealing “O”-ring that is installed around the outside of slotted colander in a groove designed to receive the “O”-ring, which is located near the top of the colander. This seals the colander/filter element against the filter housing and prevents water migration around the filter element to discharge. Water enters the top of the filter element via the perforated tube inlet water flows down the perforated tube and exits radially outward, proceeds through the activated carbon and ceramic filter, then through the slotted colander to discharge of the filter housing. This design results in next to no water pressure drop through the said invention filter, and utilization of a single element carbon bed and ceramic filter enables easy change out of the filter element when required. Further, as mentioned, the user never comes in contact with the captured hazardous waste.

Re-iterating, the said invention floor mountable whole house water filter comprises an outer cylinder having input and output means present thereon for entering and exiting water. Said outer cylinder is closed on the bottom and sides, and has means for securing a top thereto. There is further present a perforated input tube which functionally attaches to said input means of said outer cylinder. A bag or ceramic filter, into which said perforated input tube centrally projects, is substantially filled with filler material, and a perforated inner cylinder surrounds said bag or ceramic filter. In use a top is secured to said outer cylinder via water sealing means such as an “O” ring, and water is entered to said input means. Said water passes through said perforated input tube, through said bag or ceramic filter and filler material therein, and through said perforated inner cylinder before exiting through said output means in said outer cylinder.

The said invention then comprises a floor mountable whole house water filter which does not develop significant back pressure to water entered thereinto, comprising:

an outer cylinder having input and output ports present thereon for entering and exiting water, said outer cylinder being substantially closed on the bottom and sides, and having means for securing a top thereto;

a top;

a perforated input tube functionally continuous with said input port of said outer cylinder;

a bag containing filler material or ceramic filter into which said perforated input tube centrally projects; and

a perforated cylinder which surrounds said bag or ceramic filter;

such that in use said top is secured to said outer cylinder and water is entered to said input port, then passes through said perforated tube, outwardly through said bag or ceramic filter and said perforated cylinder, before exiting through said output port in said outer cylinder.

The bag or ceramic filter is preferably an easily changed one piece system, and where a ceramic filter is used it can have silver embedded in the ceramic, the purpose thereof being to prevent captured bacteria from breeding or growing therein as a self sanitizing agent.

The floor mountable whole house water filter can be distinguished in that present between said input port and said perforated tube is present a pre-filter oriented such that water entered into said input port passes therethrough inwardly toward said perforated tube. The perforated tube can extend into a central hole in the pre-filter or said pre-filter can be a solid disk shape with the open top of the perforated tube projecting only part way into said disk, or being present therebelow. Further, said pre-filter can be of any functional construction, such as a wound 5 micron or 2 micron filter element, may be of a pleated construction, or may comprise beads and/or other media present in a canister. Said pre-filter can be fashioned to remove specific contaminates, such as arsenic or mercury etc. The contents of a canister can be tailored to specific needs of those using it.

A method of removing particulate and other matter from water comprises the steps of:

a) providing floor mountable whole house water filter which does not develop significant back pressure to water entered thereinto, comprising:
an outer cylinder having input and output port present thereon for entering an exiting water, said outer cylinder being substantially closed on the bottom and sides, and having means for securing a top thereto;
a top;
a perforated tube functionally continuous with said input port of said outer cylinder;
a bag filled with filler material or ceramic filter into which said perforated input tube centrally project; and
a perforated cylinder which surrounds said bag or ceramic filter;
such that in use said top is secured to said outer cylinder and water is entered to said input port, then passes outwardly through said perforated tube, then through said bag or ceramic filter and said perforated cylinder before exiting through said output port in said outer cylinder;

b) connecting said input port of said floor mountable whole house filter to a source of water, and connecting said output port to the water input system of a house or the like;

such that in use water containing particulate and other matter is caused to flow through said floor mountable whole house filter such that said particulate and other matter is substantially removed, followed by said water with the particulate and other matter substantially removed entering said house.

The step of providing a bag containing filler material or ceramic filter containing filler material comprises providing a one piece system.

Said method can further comprise providing, between said input port and said perforated tube, a pre-filter oriented such that water entered into said input port passes therethrough inwardly toward said perforated tube.

Said method can further comprise the step of removing said top from said outer cylinder, easily removing said bag containing filler material or ceramic filter one piece system, and replacing it with another one piece bag containing filler material or ceramic filter system, followed by re-securing the top to the outer cylinder.

### Oil/Water Filter

Continuing, in more detail, Pending application Ser. No. 11/452,012 Filed Jun. 14, 2006 discloses a system in which the upper majority, (eg. ⅔), thereof has a media comprised of a combined mixture of plastic beads packed to a functional compaction level in a cylinder, (eg. an 8×36 inch cylinder). At the bottom of said cylinder there is an “end bell”, exemplified as comprising a 4 inch band of holes, optionally in a specific pattern and of a functional size. The top of the said invention is sealed with a top cap which has an exemplary 1 inch diameter hole in the center thereof through which, in use, oily water is pumped thereinto under pressure and, preferably at a functional pressure pulse rate. The result is that the said invention media adsorbs the oil from the water. It is noted that pulse action has been found to allow the said invention media to expand and have required contact time with the oily water to remove substantially all oil present. The pump increases the discharge pressure, which is the inlet pressure less a drop resulting across oil absorbed in said invention polypropylene media. The plastic beads mixed with the polypropylene ensure that oily water will continue to flow through the said Invention. If plastic particulates are not present it has been found that the separated oil will collect in the polypropylene and create a blockage which prevents further flow of oily water therethrough. The lower minority, (eg. ⅓), of the said invention is 100% polypropylene packet to a functional density to effectively remove any trace oil from the oily water that was not captured in the top of the present invention. Clean water then discharges in a radial flow via the band of perforation (holes) located near the bottom end bell of the said invention housing.

Re-iterating, this embodiment of the invention comprises a filter for separating oil, or other non-water component, from water. The preferred embodiment is comprised of an outer cylinder having input and output means present thereon, for entering a mixture of water and oil and exiting water. Said outer cylinder is closed on the sides and on the bottom thereof and has means for securing an inner cylinder/colander therewithin which is filled with a mixture of polypropylene and plastic beads in the upper approximately ⅔ thereof, and polypropylene in the lower approximately ⅓ thereof. Said filter has permeable means at the bottom thereof. In use a said top is secured to said outer cylinder and a mixture of oil and water is entered to the input means, flows through said mixture of polypropylene and plastic beads in the upper approximately ⅔ thereof, and polypropylene in the lower approximately ⅓ thereof, and through said permeable means at the bottom of the inner cylinder/colander. Water exits through said output means of the outer cylinder, and oil is accumulated in the polypropylene and plastic beads. The preferred location in said system, for the ceramic with anti-microbial embedded therewithin, and granular activated charcoal, it is noted is in the region where water exits.

The presently disclosed invention provides that any of the foregoing embodiments be functionally combined with a components that contain ceramic with anti-microbial embedded therewithin and activated charcoal.

### ADDITIONAL DISCLOSURE

### Local Filter

The present Disclosure further provides that a water filter system can comprise a combination manifold and valve system comprising:

a central structural element which has a substantially closed top and sides, said sides having first and second openings therein, each of which is suitable for attaching thereto a fluid carrying pipe, said central structural element having therewithin a substantially circular inner cavity;

there being, during use, a filter module secured to the lower extent of said central structural element as viewed in side elevation, said filter module comprising an outer cylinder which contains a ceramic filter having sides and a bottom such that a space is present within said ceramic filter, there being present within said space polypropylene and plastic beads distributed in a manner selection selected from the group consisting of:
said plastic beads and polypropylene are randomly distributed in said ceramic filter;
said plastic beads and polypropylene and are uniformly distributed in said ceramic filter;
said plastic beads polypropylene and are distributed in said ceramic filter such that the relative concentration of plastic beads is higher at an upper extent thereof and the relative concentration of polypropelene is higher at the lower extent thereof;
said plastic beads polypropylene and are distributed in said ceramic filter such that the relative concentration of plastic beads is substantially 100% at an upper extent thereof and the relative concentration of polypropelene is higher at the lower extent thereof, but not 100%;
said plastic beads polypropylene and are distributed in said ceramic filter such that the relative concentration of plastic beads is substantially 100% at an upper extent thereof and the relative concentration of polypropelene is higher at the lower extent thereof is 100%;
   said filter module being circumscribed on at least the outer surface of said sides by permeable means, (eg. polypropylene sheet), for physically protecting said ceramic;
   in said substantially circular inner cavity there being snuggly present a rotatable structural element having a top and a side wall, said rotatable structural element having first and second openings in said wall, which openings are functionally projected inwardly and then downward in the form of unequal lengths of pipe-like elements such that fluid entered into one thereof passes through said filter module which is affixed to the lower aspect of said combination manifold and valve system and out of the other thereof;
   said first and second openings in said central structural element and said first and second openings in said rotatable structural element wall being arranged with respect to one another such that when the first of the openings in said central structural element and the first of said openings in said rotatable structural element wall are aligned by relative rotation therebetween, then simultaneously so are the second openings in the central structural element and said second opening is said rotatable structural element wall;
   there being a rotatably mounted single lever of said cantered element at the top of said central structural element, and there being means for securing said filter module slidably affixed to the sides of said central structural element, said cantered element and means for securing said filter module being functionally interrelated such that causing said single lever of said cantered element to rotate about a substantially vertically oriented axis causes said means for securing said filter module to slide with respect to said central structural element;
   said means for securing said filter module having hook-like structures at lower aspects thereof and a slit shaped opening thereabove, into which slit shaped opening projects a rod which is secured stationary with respect to said central structural element;
   said combination manifold and valve system filter module further comprising a lip at an upper extent thereof, which hook-like structures are of a shape to catch.
   Said slit shaped opening can be elongated and oriented such that its elongated dimension projects substantially vertically or at an angle between vertical and horizontal as viewed in side elevation.
   Said water filter system can further comprise, in said ceramic filter, additional material comprising at least one selection from the group consisting:
anti-microbial material;
activated granular charcoal;
a mixture of anti-microbial material and activated granular charcoal;
in sequence, anti-microbial material and activated granular charcoal;
in sequence, activated granular charcoal and anti-microbial material.
   Said at least one additional treatment material can be located in proximity to said ceramic filter.
   The plastic beads are typically substantially ⅛ to ¼ inch in diameter, but can be of any functional shape and size.

### Whole House Filter

A water filter system which does not develop significant back pressure to water entered thereinto can comprise:

an outer cylinder having input and output ports present thereon for entering and exiting water, said outer cylinder being substantially closed on the bottom and sides, and having means for securing a top thereto;

a top;

a perforated input tube functionally continuous with said input port of said outer cylinder;

a ceramic filter comprising a space therewithin and into which said perforated input tube substantially centrally projects, there being activated granular charcoal within said space surrounding and said perforated input tube; and

a perforated cylinder which surrounds said ceramic filter;

such that in use said top is secured to said outer cylinder and water is entered to said input port, then passes through said perforated tube, outwardly through said granular activated charcoal and ceramic filter and said perforated cylinder, before exiting through said output port in said outer cylinder.

Said ceramic filter is preferably an easily changed one piece system comprising sides and a bottom.

Said ceramic filter can have anti-microbial embedded in the ceramic, the purpose thereof being to prevent captured bacteria from breeding or growing therein as a self sanitizing agent, a non-limiting example of which anti-microbial is silver.

Further, the ceramic filter can be circumscribed on at least the outer surface of said sides by permeable means, (eg. polypropylene sheet), for physically protecting said ceramic.

Said permeable means is sandwiched between the ceramic filter and inner surface of the perforated cylinder. This provides the ceramic with a buffered contact to the strength providing perforated cylinder.

### Oil/Water Filter

A water filter system can comprise a filter for separating at least one additional component from water, said water filter system further comprising:

an outer cylinder having input and output means present thereon for entering a mixture of water and at least one additional component and exiting water, respectively, said outer cylinder being closed on the sides and on the lower extent thereof, said outer cylinder having means for securing a top thereto;

a top;

an inner cylinder/colander which is filled with polypropylene and plastic beads distributed in a manner selection selected from the group consisting of:

said plastic beads and polypropylene are randomly distributed in said inner cylinder/colander;
said plastic beads and polypropylene and are uniformly distributed in said inner cylinder/colander;
said plastic beads polypropylene and are distributed in said inner cylinder/colander such that the relative concentration of plastic beads is higher at an upper extent thereof and the relative concentration of polypropelene is higher at the lower extent thereof;
said plastic beads polypropylene and are distributed in said inner cylinder/colander such that the relative concentration of plastic beads is substantially 100% at an upper extent thereof and the relative concentration of polypropelene is higher at the lower extent thereof, but not 100%;
said plastic beads polypropylene and are distributed in said inner cylinder/colander such that the relative concentration of plastic beads is substantially 100% at an upper extent thereof and the relative concentration of polypropelene is higher at the lower extent thereof is 100%;
   inner cylinder/colander further having permeable means at the bottom thereof;
   such that in use a said top is secured to said outer cylinder and a mixture of said at least one additional component and water is entered to the input means, flows through said mixture of polypropylene and plastic beads and polypropylene, then through said permeable means at the bottom of the inner cylinder/colander before water exits through said output means of the outer cylinder.
   Said water filter system can further comprise, in said inner cylinder/colander, additional material comprising at least one selection from the group consisting:
anti-microbial material;
activated granular charcoal;
a mixture of anti-microbial material and activated granular charcoal;
in sequence, anti-microbial material and activated granular charcoal;
in sequence, activated granular charcoal and anti-microbial material.
   Said at least one additional treatment material is located in proximity to said permeable means of said cylinder/colander.
   The plastic beads are typically substantially ⅛ to ¼ inch in diameter, but can be of any functional shape and size.
   Said water filter system can further comprise a ceramic filter which comprises sides and a bottom with a space being present therewithin which is present inside said inner cylinder/colander, and within which ceramic filter are present said polypropelene and plastic beads.

In any of the forgoing where a ceramic filter is present said ceramic can have a pore size of about 0.9 micron or less.

It is also disclosed that a water filter apparatus can comprise a sequence of a combination of first and second water filters:
said first water filter system providing means for separating at least one non-water component from water comprising an inner cylinder/colander which is filled with polypropylene and plastic beads distributed in a manner selection selected from the group consisting of:
   said plastic beads and polypropylene are randomly distributed in said inner cylinder/colander;
   said plastic beads and polypropylene and are uniformly distributed in said inner cylinder/colander;
   said plastic beads polypropylene and are distributed in said inner cylinder/colander such that the relative concentration of plastic beads is higher at an upper extent thereof and the relative concentration of polypropelene is higher at the lower extent thereof;
   said plastic beads polypropylene and are distributed in said inner cylinder/colander such that the relative concentration of plastic beads is substantially 100% at an upper extent thereof and the relative concentration of polypropelene is higher at the lower extent thereof, but not 100%;
   said plastic beads polypropylene and are distributed in said inner cylinder/colander such that the relative concentration of plastic beads is substantially 100% at an upper extent thereof and the relative concentration of polypropelene is higher at the lower extent thereof is 100%;
      and
said second water filter system being constructed to not develop significant back pressure to water entered thereinto from the output of said first water filter system, because water entered thereinto flows radially from a central location therein toward a larger area outer location.

Said first water filter system can further comprise, in the inner cylinder/colander thereof, additional material comprising at least one selection from the group consisting:
anti-microbial material;
activated granular charcoal;
a mixture of anti-microbial material and activated granular charcoal;
in sequence, anti-microbial material and activated granular charcoal;
in sequence, activated granular charcoal and anti-microbial material.

Said second water filter system can further characterized as being comprised of an outer cylinder having input and output ports present thereon for entering and exiting water, said outer cylinder being substantially closed on the bottom and sides, and having means for securing a top thereto;

a top;

a perforated input tube functionally continuous with said input port of said outer cylinder;

a bag or ceramic filter comprising a space therewithin and into which said perforated input tube substantially centrally projects, there being activated granular charcoal within said space surrounding and said perforated input tube; and

a perforated cylinder which surrounds said bag or ceramic filter;

such that in use said top is secured to said outer cylinder and water is entered to said input port, then passes through said perforated tube, outwardly through said granular activated charcoal and ceramic filter and said perforated cylinder, before exiting through said output port in said outer cylinder.

Further, said water filter apparatus can further comprise a third water filter system which provides a final stage of water filtering to water entered thereinto from the output of said second water filter and provide as output, high quality potable water. The preferred third water filter system can be further characterized as being comprised of a combination manifold and valve system to which a filter module removably attaches, said combination manifold and valve system being constructed such that when the manifold is operated to allow affixing a filter module the valve(s) in the manifold are caused to be closed, and when the manifold is operated to securely affix a filter module thereto, the valve(s) in the manifold are caused to be open, said system being characterized in that a single lever which rotates no more than ¼ turn, completely and substantially simultaneously controls both the valves and filter module mounting.

Where a sequence of filtering systems are present the purpose is to produce potable water from a wide variety of input steams.

The said invention will be better understood by a reading of the Detailed description Section of this Disclosure with reference to the Drawings.

### BRIEF DESCRIPTION OF THE DRAWINGS

FIGS. 1a and 1b show a sequential combination of separate and merged ceramic with embedded anti-microbial, and activated charcoal components.

FIG. 1c shows a component in which are mixed ceramic with embedded anti-microbial, and activated charcoal components.

FIGS. 1d-1h are provided to generically show that a filter module can be configured in various functional manners. The

FIG. 1i shows a Ceramic Filter can be circumscribed with a buffer material.

Local

FIGS. 2a, 2b, 4a and 4b show side and top views of an “open” combination manifold and valve system with a filter module removably attached for a local filter.

FIGS. 3a, 3b, 5a and 5b show side and top views of a “closed” combination manifold and valve system to which a filter module can be easily removed for a local filter.

FIGS. 6a, 6b, 7a, 7b, 8a, 8b, 9a and 9b are additional views of the said invention system and provide insight to the system of the said invention for a local filter.

FIGS. 10a-10e show detail of the filter module construction for the system of FIGS. 2a-9b for a local filter.

FIGS. 10f1, 10f2 and 10f3 show side elevational and bottom views and an internal filter element of a filter module which can be packed with activated granular charcoal and anti-microbial, or with plastic beads and polypropelene.

Whole House

FIG. 11a shows an elevational cross-sectional view of a basic version of the said invention whole house water filter.

FIGS. 11b and 11c show elevational cross-sectional views of a version of the said invention whole house water filter including a Pre-Filter.

FIG. 12a shows generally a Bag or Ceramic Filter for application in the said invention whole house water filter.

FIGS. 12b and 12c show a Pre-Filter for application in the present invention whole house water filter.

FIGS. 12d1 and 12d2 show top and side elevational views of a ceramic filter circumscribed with a permeable sheet inside a perforated cylinder.

FIG. 13 shows a partially assembled side elevational view of the exterior of the system in FIGS. 11a-12c.

FIG. 14 shows an assembled view of the exterior of the system in FIGS. 11a-12c.

FIG. 15 is a cross-sectional taken at b-b in FIG. 14, and shows a Perforated Input Tube projects into a Bag filled with a filler material or Ceramic Filter, said bag or ceramic filter being secured within a Perforated Cylinder.

Oil/Water

FIG. 16 shows a partially constructed side elevational cross-sectional taken at b-b in FIG. 17 of a system for separating oil from water.

FIG. 17 shows a top secured in place to an Outer Cylinder and Inner Cylinder/Colander of the system shown in FIG. 16.

FIG. 18 shows a top view of the top identified in FIG. 17.

FIG. 19 demonstrates a sequential combination of systems as shown in, respectively, FIGS. 16-18, 11a-15 and 2a-10e.

### DETAILED DESCRIPTION

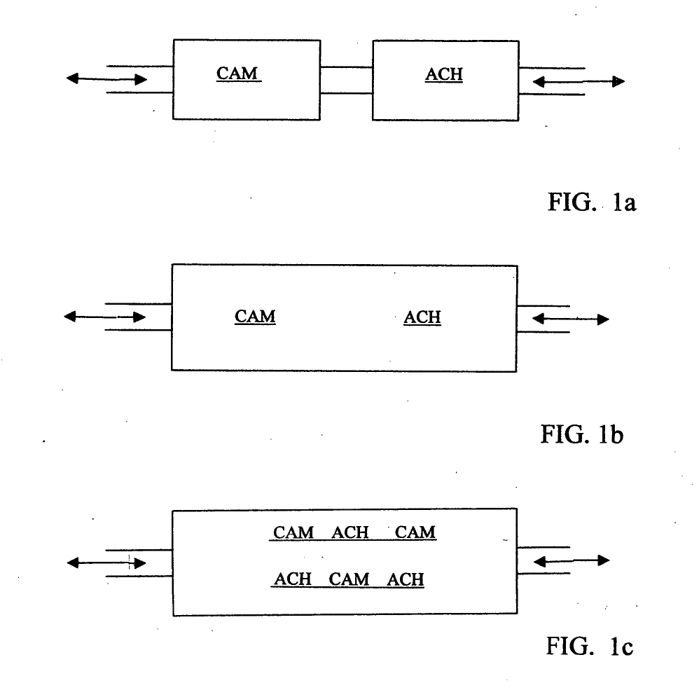

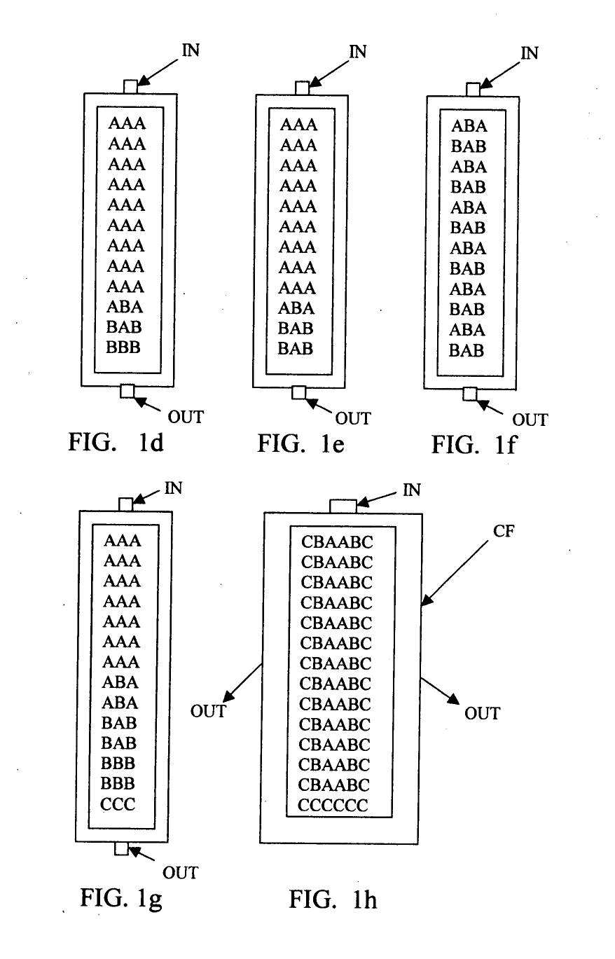

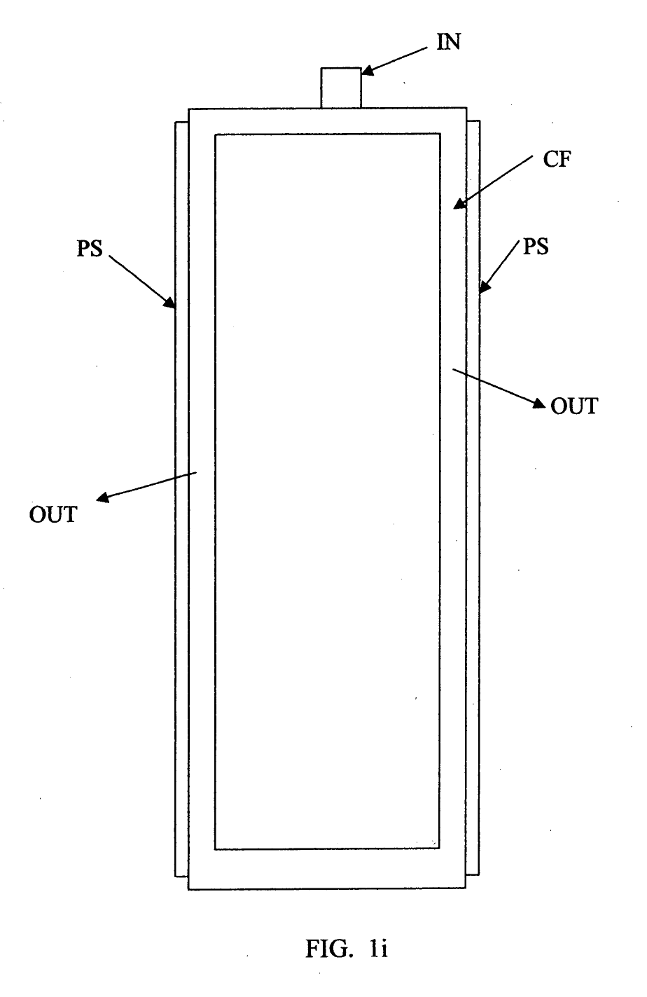

FIGS. 1a and 1b show a sequential combination of separate and merged ceramic with embedded anti-microbial (CAM), and activated charcoal (ACH). The shown, or functional equivalents thereof are integrated into the various embodiments described below. FIG. 1c shows a component in which are mixed ceramic with embedded anti-microbial (CAM), and activated charcoal (ACH). Note that flow can be considered to flow through the systems in FIGS. 1a-1c in either direction, so that, for instance (ACH) is encountered first in FIGS. 1a and 1b, but flow will be in one direction during actual use, (ie. once flow is started in a filtering procedure, it will proceed in the same direction until the procedure is furnished).

FIGS. 1d-1h are provided to generically show that a filter module can be configured in various functional manners. The identifiers “A”, “B” and “C” are to be interpreted to indicate different packing materials. FIG. 1d shows a Filter can be packed with, for instance, Plastic Beads (eg. “A”) and Polypropylene (eg. “B”) or Granular Activated Charcoal (eg. “A”) and Anti-microbial (eg. (B) or (C)). Note that the concentration of “A” is 100% at the upper aspect and that the concentration of “B” is 100% at the lower aspect. FIG. 1e shows that the concentration of “A” can be 100% at the upper aspect with some thereof remaining at the lower aspect. FIG. 1f indicates that “A” and “B” can be substantially randomly distributed throughout the entire length of the Filter. FIG. 1g shows that a third component “C”, (eg. an Anti-microbial) as well, and demonstrates one possible concentration sequence or “A”, “B” and “C”. FIGS. 1d-1g show Filters with definite Input (IN) and Output (OUT) ports. FIG. 1h demonstrates that a Ceramic Filter (CG) can be present which has a definite Input (IN) Port and which encloses various components “A”, “B” and “C”, but provides that the Output (OUT) be through the walls thereof. One possible concentration pattern of “A”, “B” and “C” is shown that would cause water input to the Input Port (IN) to encounter all components before exiting through the Ceramic Filter wall. Note that not all “A”, “B” and “C” components would have to be present, and that the Ceramic can have Anti-microbial embedded therewithin. FIGS. 1a-1h are to be understood as demonstrative and not limiting.

It is noted that where (A) and (B) are Granular Activated Charcoal (ACH) and Anti-microbial (CAM) systems such as shown in FIGS. 1a-1c result. It is also noted that the (ACH) and (CAM) can be present in a Filter Module which is incorporated in a Filter System. That is, FIGS. 1a-1c show functional configurations and do not necessarily represent separate module(s) added to an otherwise self-contained system.

FIG. 1i shows a Ceramic Filter (CF) can be circumscribed with a buffer material (PS) so that its contact with, for instance, a colander, will reduce damaging forces to be applied thereto. The material can be, but is not limited to, a Permeable Sheet such as a Polypropelene Sheet.

### Local Filter

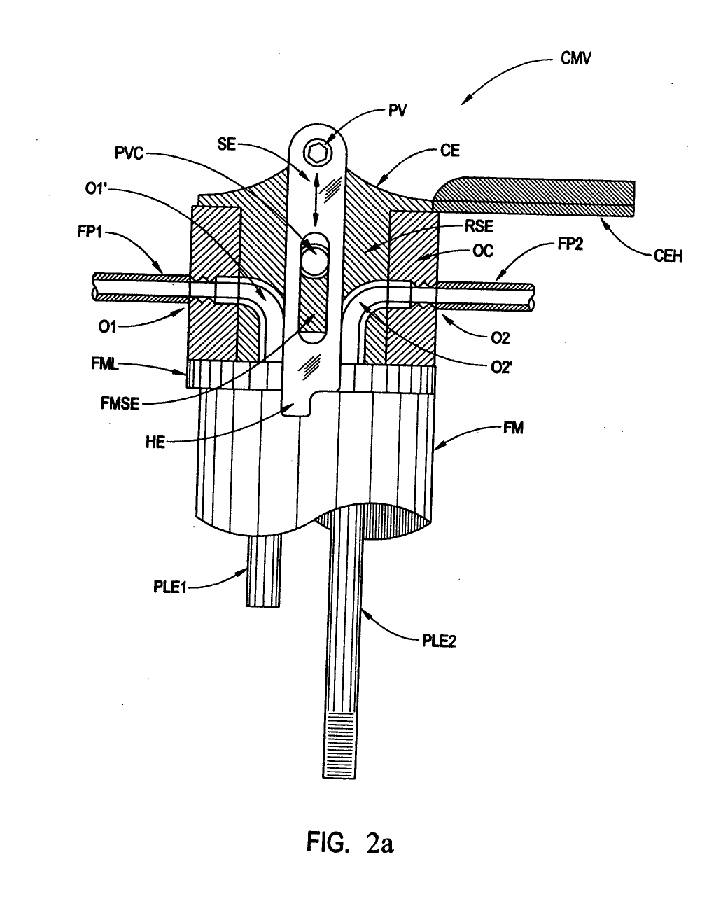

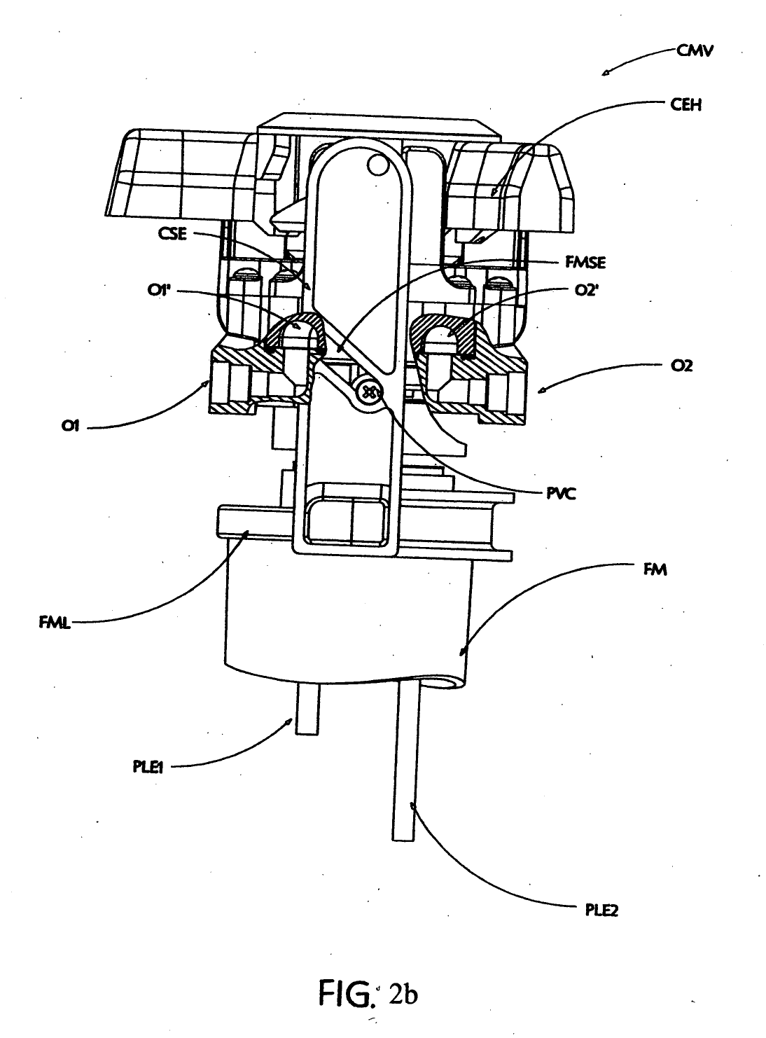

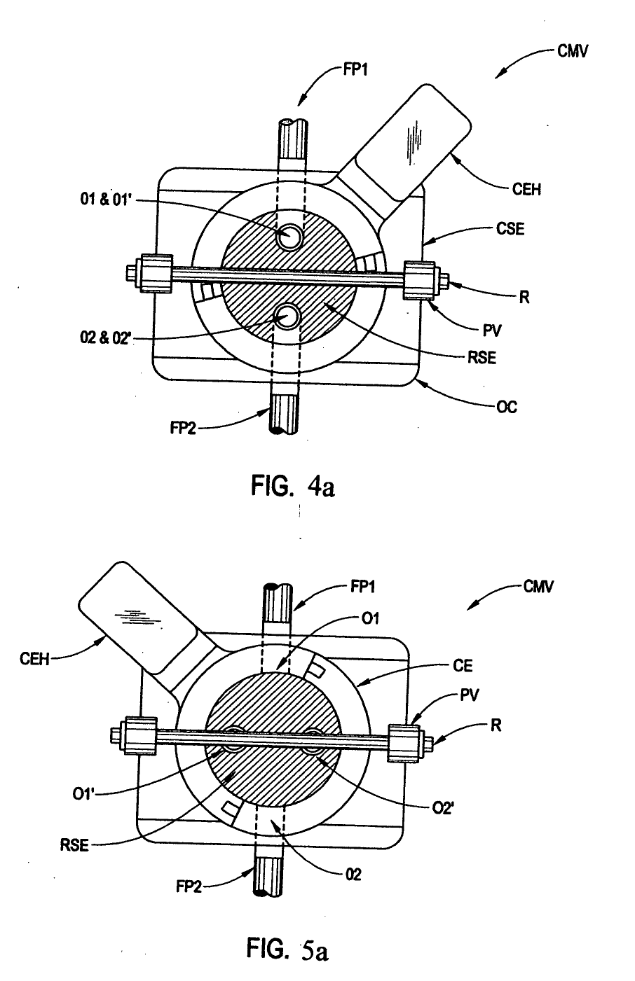

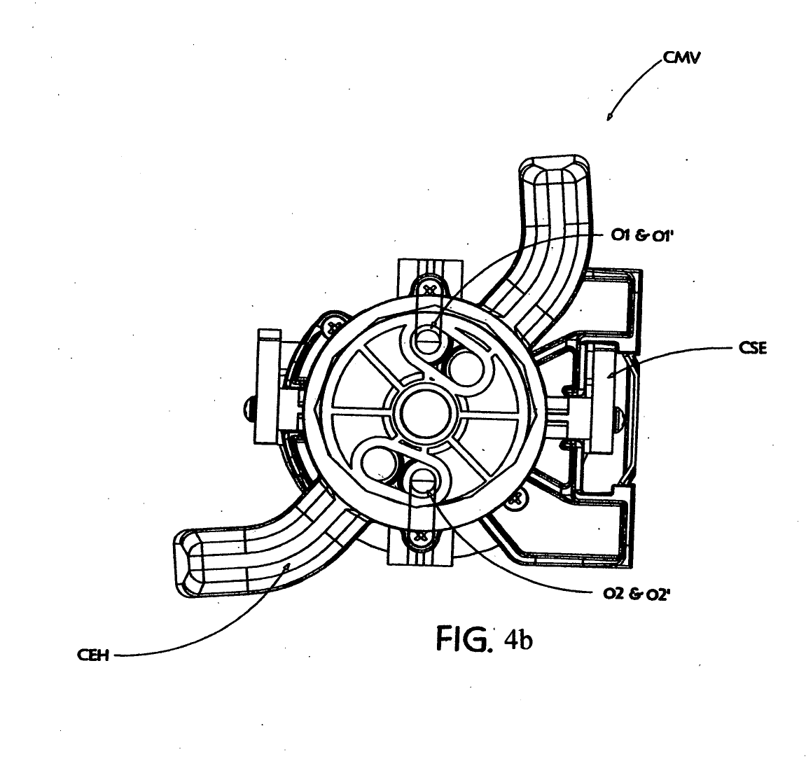

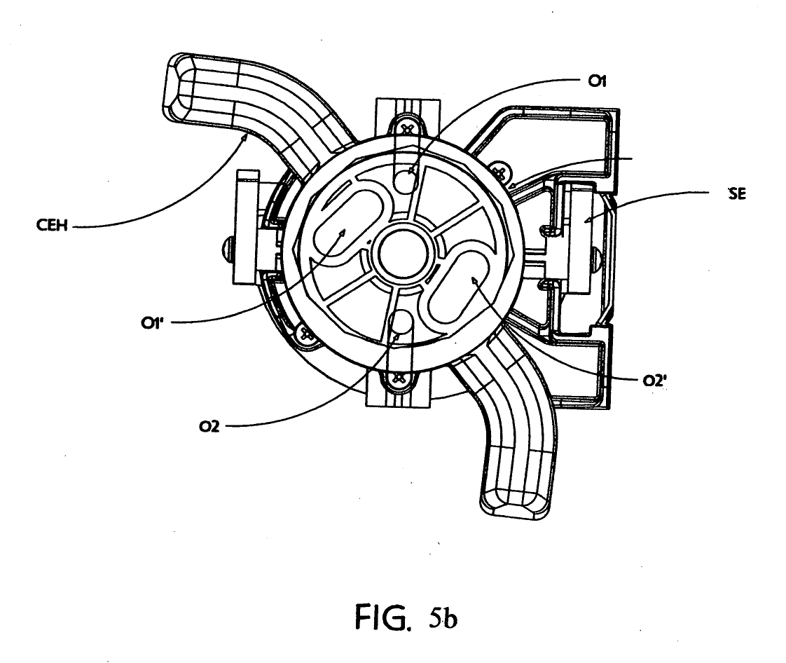

Continuing, it is first noted that two embodiments of a first system are demonstrated. FIGS. 2a, 3a, 4a, 5a, 6a, 7a, 8a and 9a show one embodiment and FIGS. 2b, 3b, 4b, 5b, 6b, 7b, 8b and 9b another. A major distinction between the embodiments is found in an elongated dimension of a slit (FSME) shaped opening being projected vertically or at an angle between vertical and horizontal.

FIGS. 2a-5b show the said invention combination manifold and valve system (CMV) that comprises a central structural element (CSE) which has a substantially closed top and sides. Said sides have first (O1) and second (O2) openings therein, each of which is suitable for attaching thereto a fluid carrying pipe (FP1) (FP2). It is noted that a preferred attachment means is a John Guest Coupler placed inside (O1) or (O2) which allows mounting a pipe via a simply pushing it thereinto.

During use, a filter module (FM) comprising filter media therewithin, is secured to the lower extent of said central structural element (CSE). Present in said central structural element (CSE) there is a substantially circular (as viewed from above), inner cavity, in which is a rotatable structural element (RSE) has first (O1′) and second (O2′) openings in said wall, which openings are functionally projected inwardly into said inner circular cavity and then downward in the form of unequal lengths of pipe-like elements (PLW1) (PLE2). In use, fluid entered into one pipe-like element (PLW1) (PLW2) passes through said filter module (FM) which is affixed to the lower aspect of said combination manifold and valve system (CMV) and out of the other (PLW2) (PLW1) thereof. Said first (O1) and second (O2) openings in said central structural element (CSE) and said first (O1′) and second (O2′) openings in said rotatable structural element (RSE) in the inner cavity of the CSE) are arranged with respect to one another such that when the first (O1) of the openings in said central structural element (CSE) and the first (O1′) of said openings in said rotatable structural element (RSE) are aligned by relative rotation therebetween, then simultaneously so are the second (O2) openings in the central structural element (CSE) and said second (O2′) opening is said rotatable structural element (RSE). There is a cantered element (CE) at the top of said central structural element (CSE) having a single rotatable lever (CEH), and there are means for securing (SE) said filter module (FM) slidably affixed to the sides of said central structural element (CSE). Said cantered element (CE) and means for securing (FMSE) said filter module (FM) are functionally interrelated such that causing said cantered element (CE) to rotate causes said means for securing (FMSE) said filter module (FM) to slide with respect to said central structural element (CSE). Said means for securing (FMSE) said filter module (FM) have hook-like structures (HE) at lower aspects thereof, and said combination manifold and valve system (CMV) filter module (FM) further comprises a lip (FML) at an upper extent thereof, which hook-like structures (HE) are of a shape to catch.

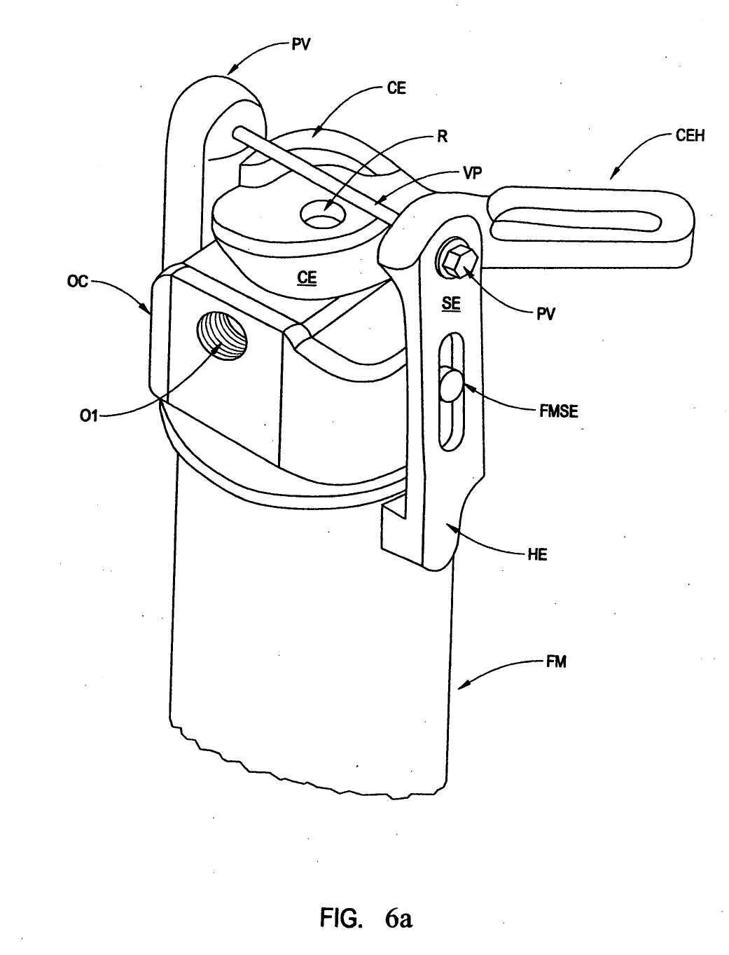

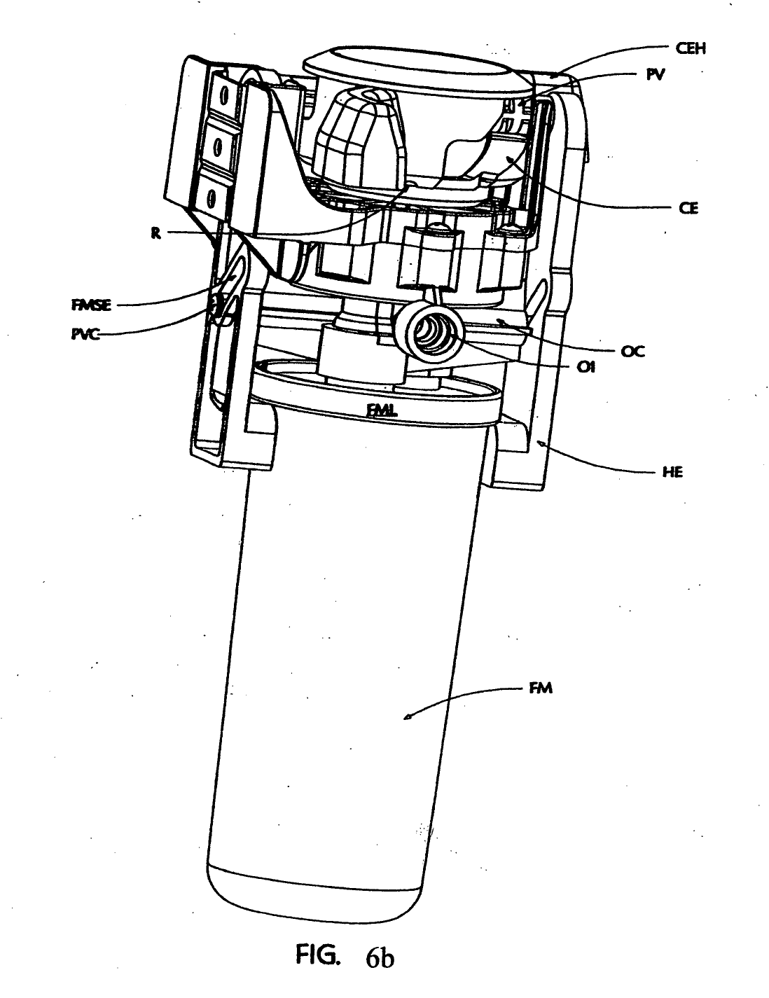

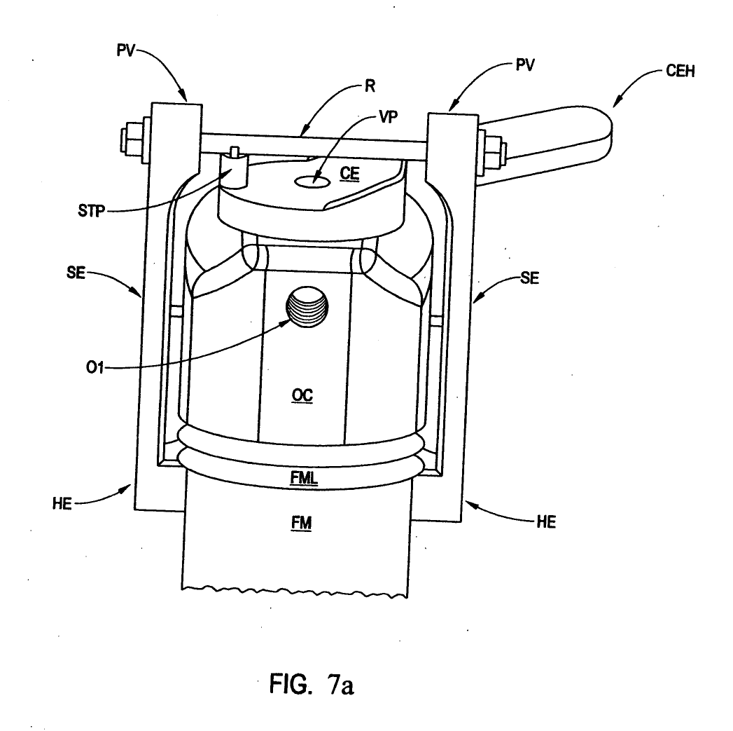

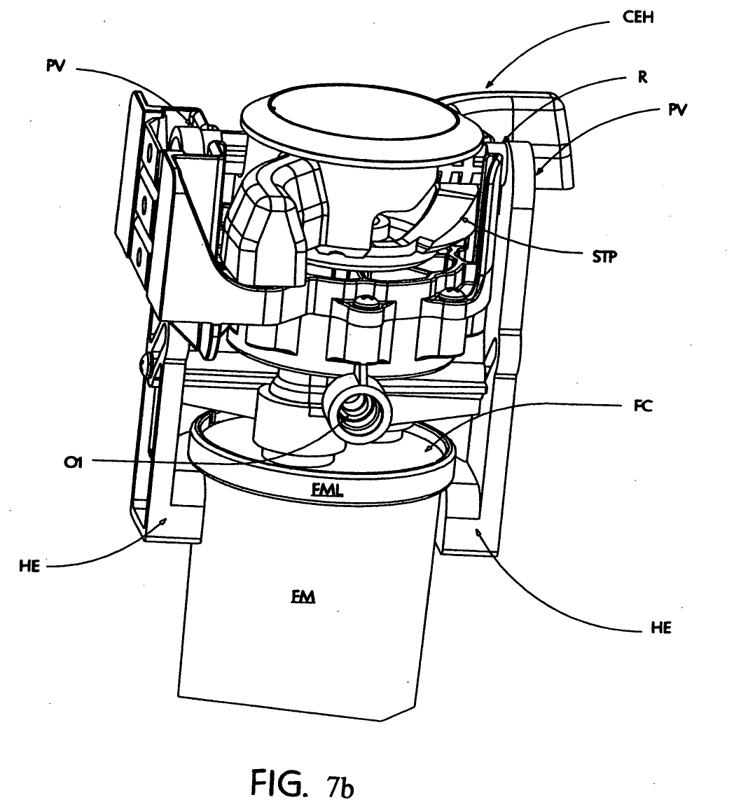

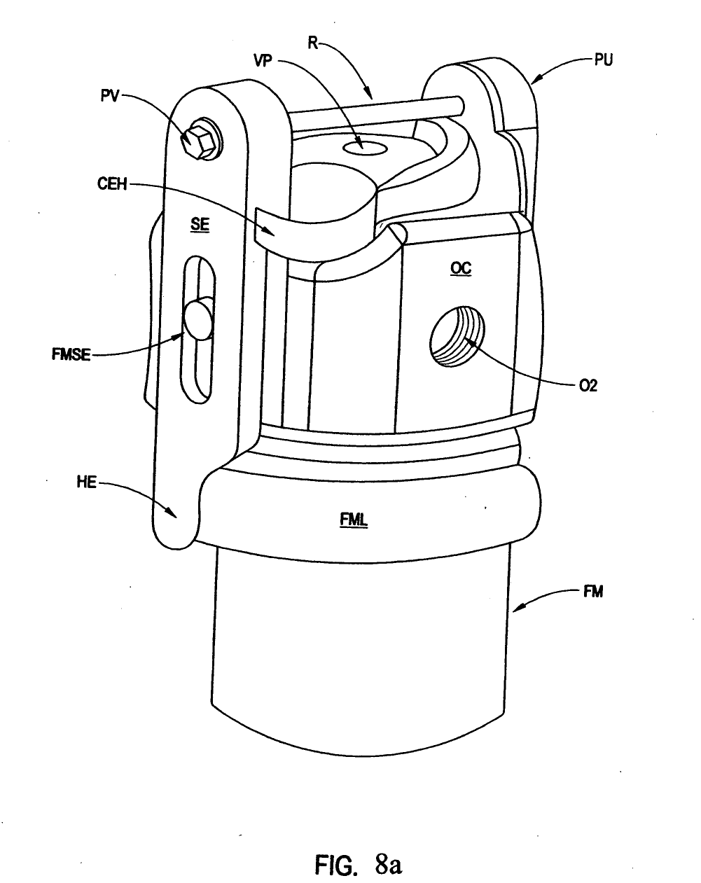

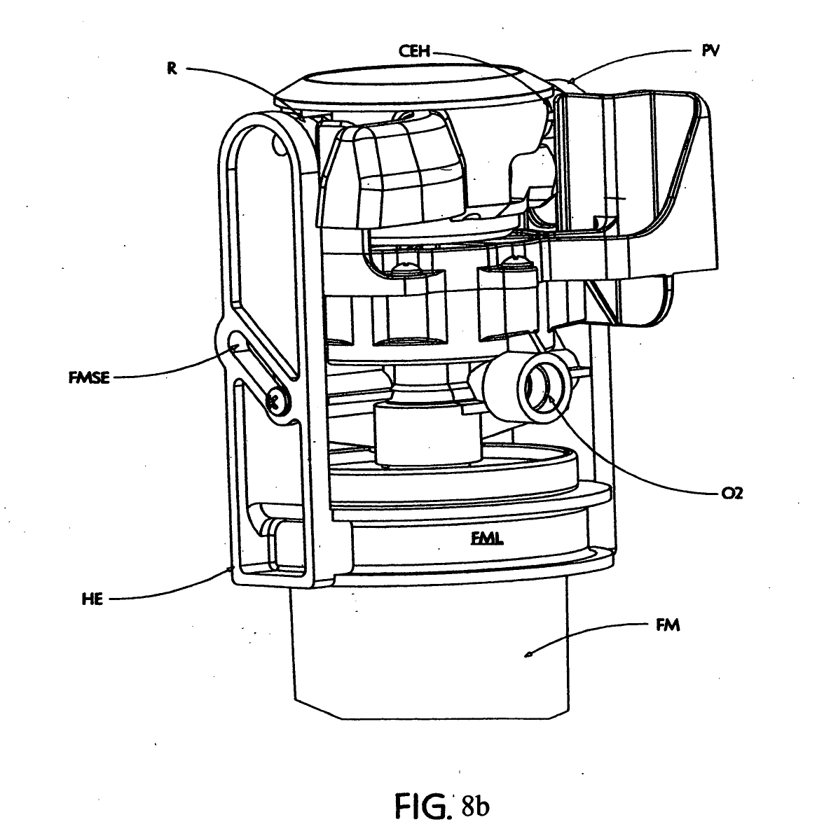

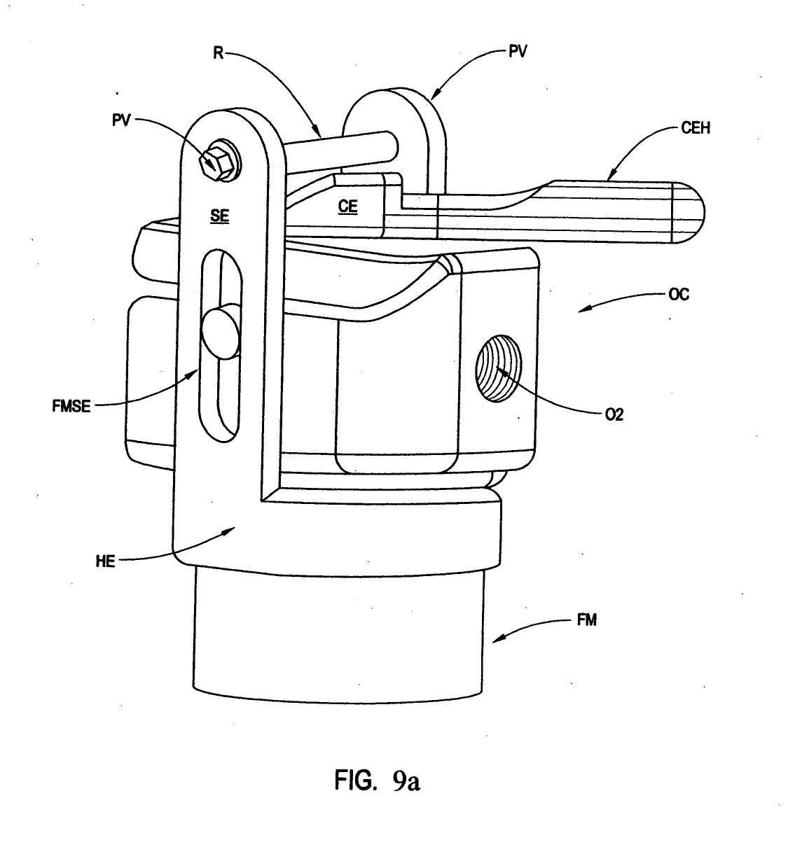

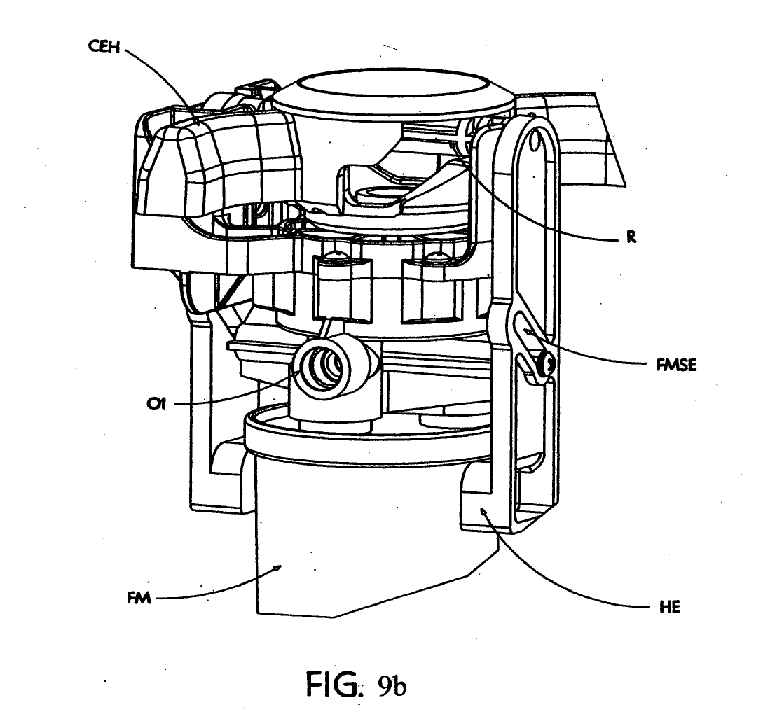

FIGS. 6a-9b provide additional insight to the system of the said invention wherein the filter module (FM) is secured to the combination manifold and valve system (CMV). In particular, note that a rod (R) projects between Pivots (Pv) that secure said means for securing (FMSE) said filter module (FM). Also note that said rod (R) rides atop said cantered element (CE), such that when lever (CEH) is caused to be rotated about a substantially vertical axis (VP), (viewed in side elevation as shown), said rod (R), and hence said means for securing (SE) said filter module (FM) having hook-like structures (HE) at lower aspects thereof, are caused to be raised and lowered. The FIGS. 2a-9b show an embodiment of the said invention in which rotation of the lever (CEH) in a clockwise direction, as viewed from above, secures the filter module (FM) to the combination manifold and valve system (CMV) also aligns (O1) to (O1′) and (O2) to (O2′). It is to be understood that another embodiment provides that the lever (CEH) rotates counter-clockwise, similarly viewed, to effect a similar alignment of (O1) to (O1′) and (O2) to (O2′). It is further noted that said single rotatable lever can be of a single projection construction or can have two projections oriented at 180 degrees from one another about a centrally located vertically oriented axis, or can be of any other functional configuration. FIGS. 7a and 7b show the hook-like structures (HE) at the lower extents of (SE) which catch the lip (FML) located at the upper aspect of said filter module (FM), and also show first opening (O1). It is to be understood that hook-like structures (HE) can be independently present on two means for securing (SE) said filter module (FM), or the means for securing (SE) said filter module (FM) can be of a half circle in shape, as viewed from atop or from below, and the means for securing (SE) said filter module (FM) can be distributed continuously or piecewise over all or a part thereof. Note that a stop rotation element (STP) is also shown in FIGS. 7a and 7b, but differ in embodiment. FIG. 8a shows the system of the said invention from the opposite side as that in FIG. 7a, such that outlet opening (O2) is visible. FIG. 9a shows another view of the said invention system showing the elements shown in FIG. 8a.

Note that FIGS. 6a, 6b, 8a, 8b, 9a and 9b further show that the means for securing (SE) said filter module (FM) having hook-like structures (HE) at lower aspects thereof, comprise a slit shaped opening (FSME), into which slit shaped opening (FSME) projects a rod (PVC) which is secured stationary with respect to said central structural element (CSE). Said rod (PVC) can be secured directly to said central structural element (CSE) or to a outer covering (OC) which at least partially contains said central structural element (CSE). Note that the operation of the slit shaped opening (FSME) and rod (PVC) is to provide guidance for the vertical motion of the filter module (FM) with respect to the central structural element (CSE) when the lever (CEH) is caused to be rotated about a substantially vertical axis (VP). Note that said (FSME) slit shaped opening is elongated and oriented such that its elongated dimension projects substantially vertically, as shown in FIGS. 8a and 9a, or as shown in FIGS. 8b and 9b, such that its elongated dimension projects at an angle between vertical and horizontal. The later configuration has been found to provide better strength and certainty of operation.

It is noted that the designation (OS) in various drawings indicates the outer surface of the central structural element (CSE) per se., or a covering which substantially contains the central structural element (CSE).

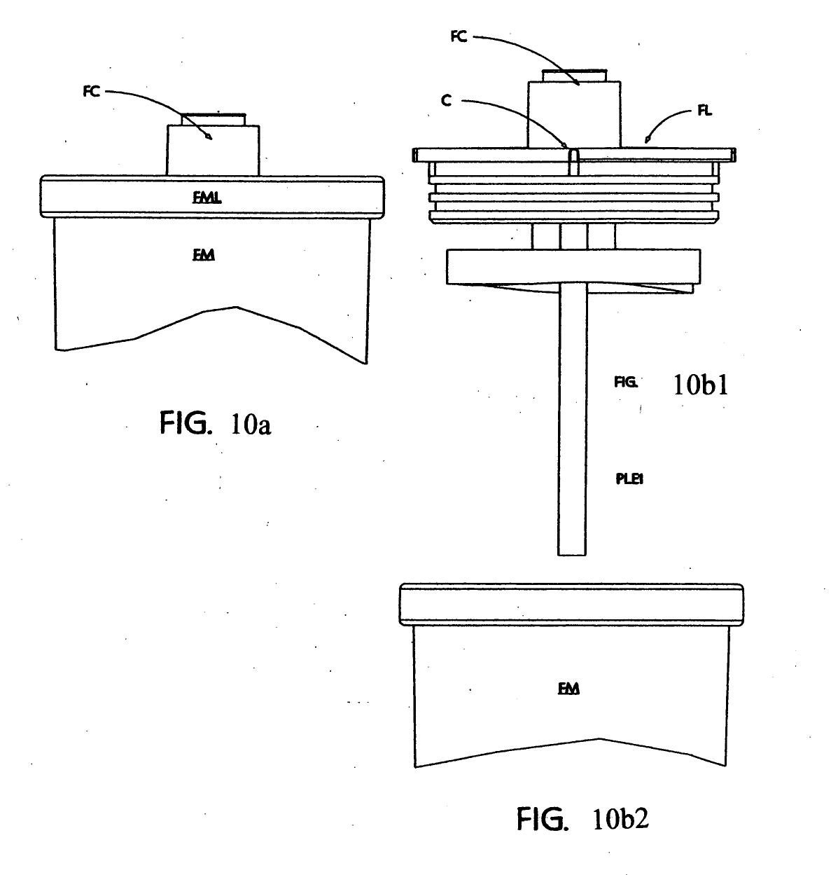

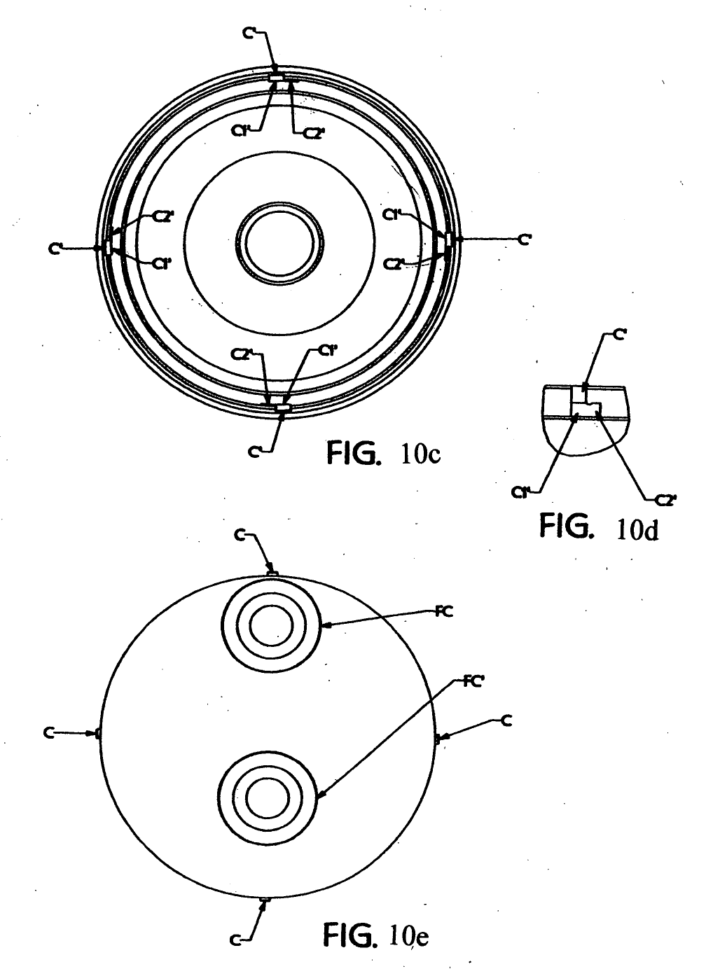

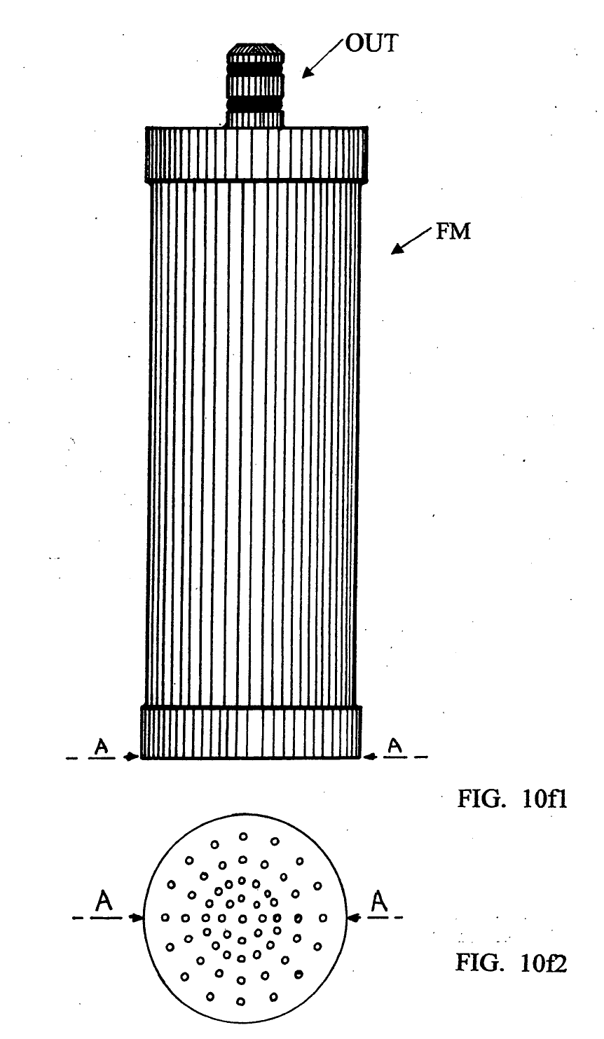

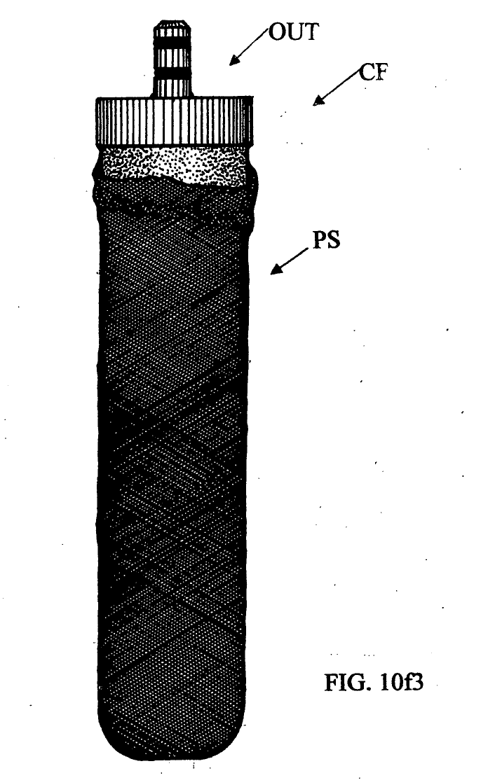

Continuing, FIGS. 10a-10e show detail of the filter module (FM) construction. FIG. 10a shows a cut-away view of the upper portion of the filter module (FM) with a filter coupler (FC) indicated. FIGS. 10b1 and 10b2 show that the filter coupler (FC) is attached to a filter lid (FL) which can be removed from the filter module (FM). As indicated by FIGS. 10c, 10d and 10e, the preferred approach to coupling the filter lid (FL) to the filter module (FM) is by way of sliding nibs (C) into receptors (C1′) in a filter module outer covering and then causing a slight rotation motion of filter lid (FL) so that nibs (C) are positioned in receptor portions identified as (C2′). FIGS. 10c and 10e show top views and FIG. 10d shows a side elevational view of the receptors (C) as they would appear looking from the inside of the filter module (FM) toward the filter module lip (FML). Note that FIG. 10e also shows that filter couplers (FC) can be positioned in the filter lid (FL) so that there is only one way that the filter lid (FL) can be fit into the central structural element (CSE) of the combination manifold and valve system. This, of course requires complimentary design of the location of the downward projections of the unequal lengths of pipe-like elements (PLE1) (PLE2) in the central structural element which functionally couple to said filter couplers (FC) when the said invention combination manifold and valve system to which a filter module removably attaches, is being used to filter fluid.

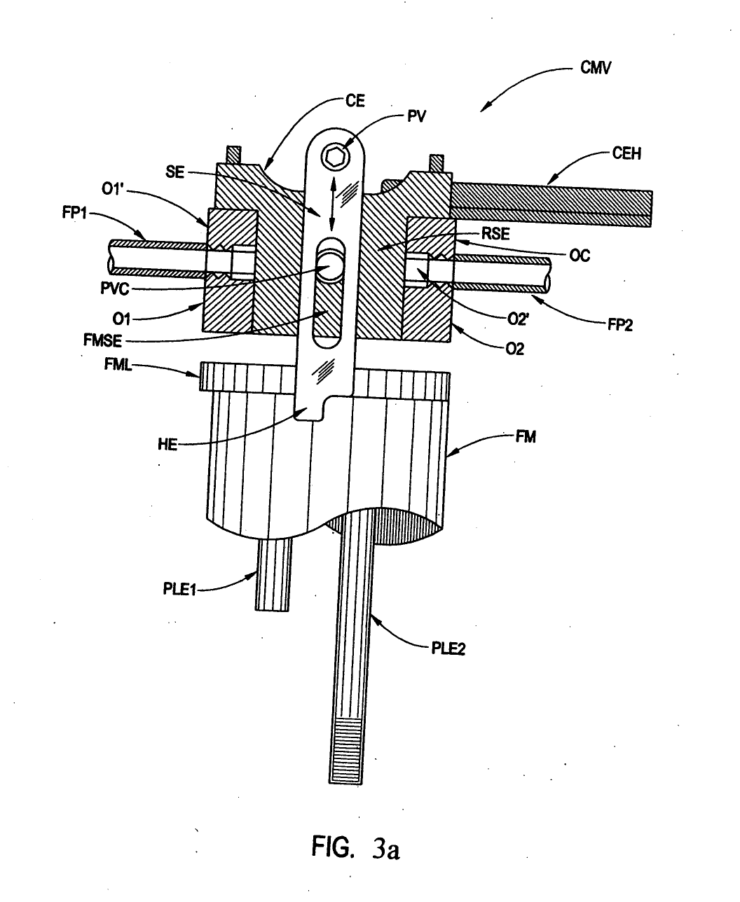

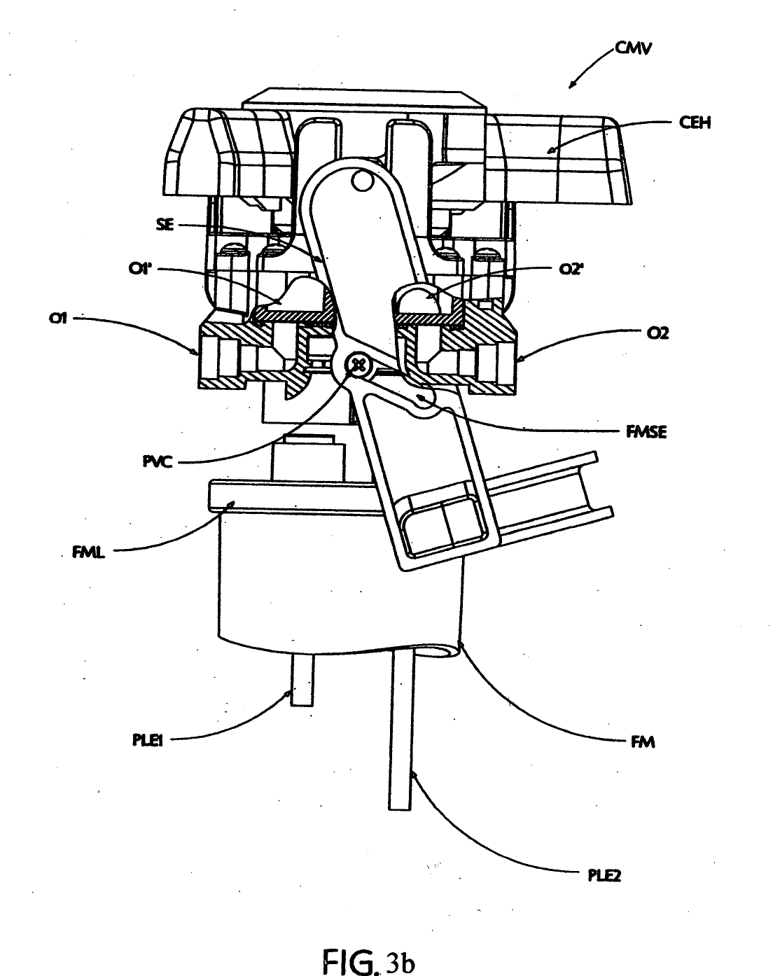

FIGS. 10f1 and 10f2 show side elevational and bottom views of the outer appearance of a Filter Module (FM) which can be packed as exemplified in FIGS. 1a-1h with components (A) (B) (C). Said (A) (B) and (C) components can be individually selected from, for instance, Activated Granular Charcoal and Anti-microbial, or with Plastic Beads and Polypropelene. Where a Filter Module (FM) as shown in FIGS. 10f1 and 10f2 is used, it is noted that Piping (PLE1) and (PLE2) as shown in FIGS. 2a, 2b, 3a 3b and 10b1 will typically not be present. Instead, the Output (OUT) of the Filter Module (FM) of FIGS. 10f1 and 10f2 will be attached to second opening (O2), and filtered water will make its way to out of first opening (O1), (see FIG. 2a, for instance, for (O1) and (O2)), after exiting through the bottom, (see FIGS. 1d-1g), or through the wall of the Filter Module (FM). The later case can occur if the Filter Module is a Ceramic Filter, as demonstrated in FIG. 1h. FIG. 10f3 shows that inside the Filter Module (FM) can be a Ceramic Filter which is circumscribed in a Permeable Sheet (PS) which serves to buffer contact with the inner surface of the outer containment as shown in FIGS. 10f1 and 10f2, similar to that shown in FIG. 1i. Note that in the FIG. 10f3 embodiment water flows into the Ceramic Filter (CM) from the outside thereof in-thereto. Water enters Opening (O1), then through the wall of the Permeable Sheet (PS) and the Ceramic Filter (CM) and then makes its way out of Opening (O2). Alternatively, water could be entered into the port labeled (OUT), and pass through the wall of the Ceramic Filter and the circumscribing Permeable Sheet (PS), and then make its way out the bottom of the Ceramic Filter and make its way to Opening (O2). Any configuration that causes water flow into, through and out of the Filter is within the scope of the present invention. Further, and packing of filter material, such those shown in FIGS. 1a-1h can be used.

It is believed that a system comprising a manifold and a cantered element comprising a single lever which is required to rotate only ¼ of a turn about a substantially vertically oriented axis, to substantially simultaneously, shut-off inlet and outlet fluid supplies, and allow dropping a filter module, therefrom, wherein the filter module comprises a filter lid and an outer cover which functionally interconnect via rotatably interconnecting nib-“L” shaped receptor means, is new, novel and non-obvious. Further, when the single lever is rotated ¼ of a turn in an opposite direction, a new filter module can be drawn into an operational position and, substantially simultaneously, the inlet and outlet fluid supplies are re-opened. No tools are required, and the simple operation makes mis-installation of a filter module essentially impossible. The multi-tasking manifold/single lever combination performs, in a single operation, what other known systems require two actions to accomplish. In addition, the filter module is designed so that the inlet and outlets thereof can only match to the inlet and outlets of the manifold, thereby preventing backward installation.

It is to be understood that the identifiers (IN) and (OUT) in FIGS. 1d-1h can be functionally identified with (PLE1) and (PLE2) in FIGS. 2a-3b. That is, the Filter Module (FM) can have any functional internal configuration which directs water input thereinto to pass through any configuration of “A”, “B”, “C” etc. components as well as, perhaps, a Ceramic Filter (CF) wall. The configuration shown in FIGS. 2a-3b is functionally demonstrative only and not limiting as to how (PLE1) and (PLE2) are actually configured.

### Whole House Filter

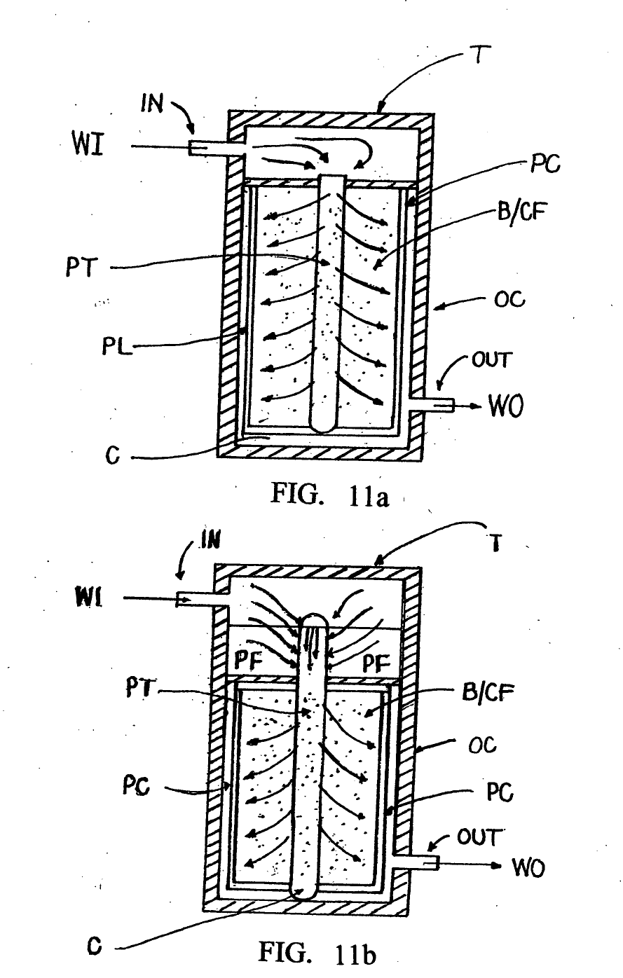

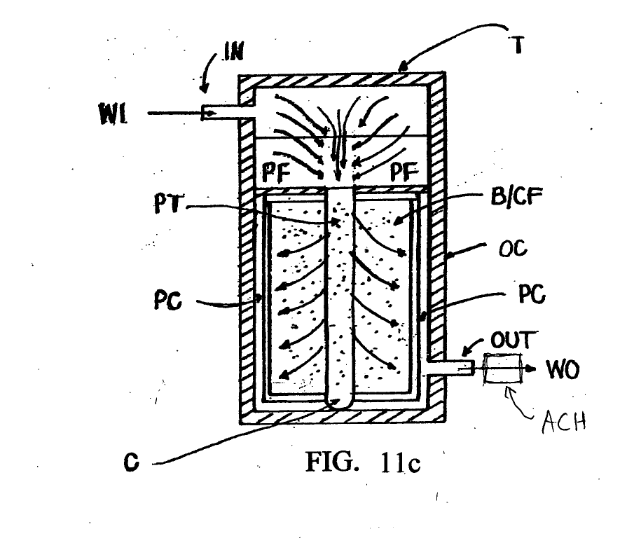

Turning now to a second embodiment, FIGS. 11a and 11b show elevational cross-sectional views of a basic and augmented versions of the said invention whole house water filter. Shown are an Outer Cylinder (OC) having Inlet (IN) and Outlet (OUT) ports for entering (WI) and exiting (WO) water. In said Outer Cylinder (OC) is an Perforated Cylinder (PC) which surrounds and holds in place a Bag or Ceramic Filter (B/CF). When a Bag is used it is filled with a Filter material (FM) such as activated charcoal. Located substantially centrally in said Bag or Ceramic Filter (B/CF) is a Perforated Tube (PT). (Note that as shown in FIG. 1i, where a Ceramic Filter is used it can be circumscribed in a Permeable Protective Sheet (PS) to buffer contact with the Perforated Cylinder (PC)). FIG. 11b shows an elevational cross-sectional view of a version of the present invention whole house water filter including a Pre-Filter (PF), but which is otherwise similar to what is shown in FIG. 11a. It is noted that while FIG. 11b shows the Perforated tube (PT) extending through a hole in the center of the Pre-filter (PF), it is within the scope of the said invention to provide that the Pre-filter (PF) be of a disc shape with the Perforated Tube (PT) extending only partially thereinto, or not at all. That is an open top of a Perforated Tube (PT) can be present below a Pre-filter (PF) without a central hole present therein.

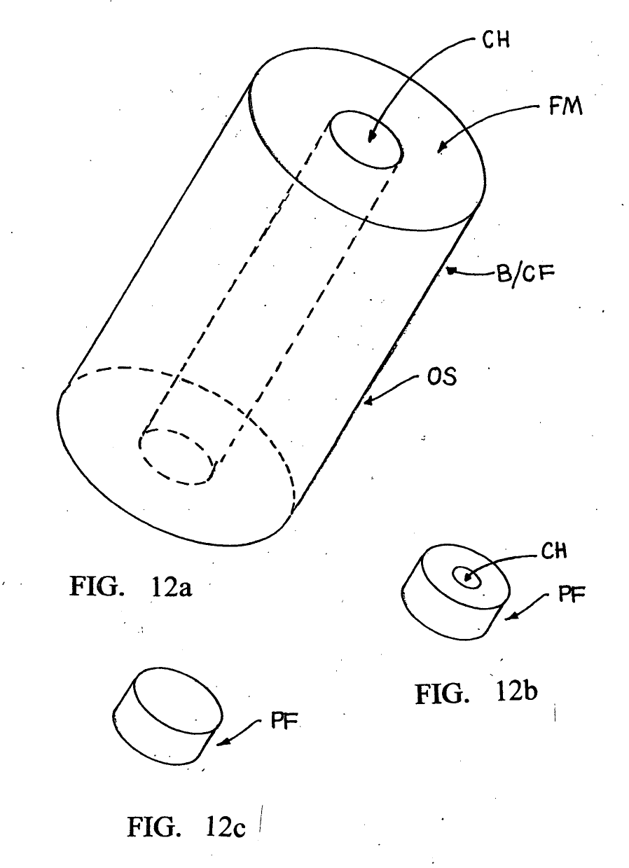

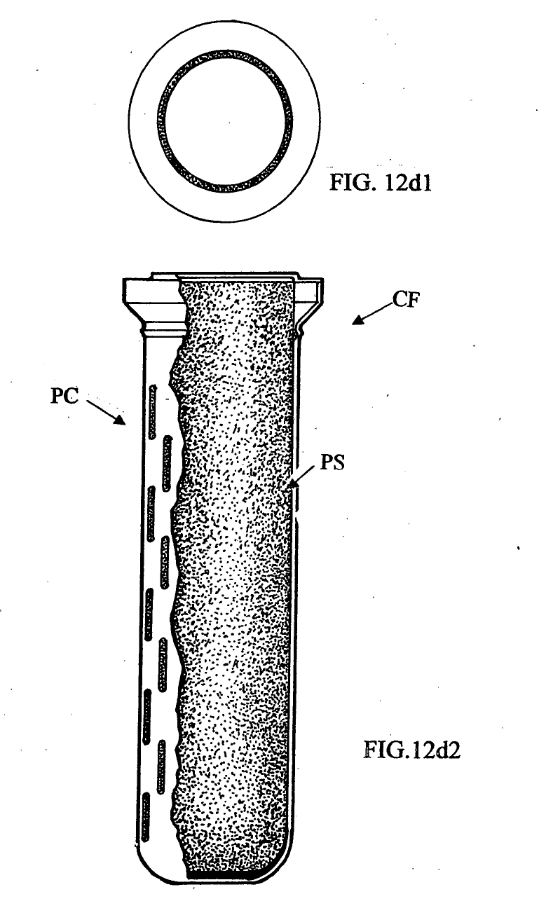

FIG. 12a shows generally a Bag or Ceramic Filter (B/CF) for application in the said invention whole house water filter, and FIG. 12b shows the generally a Pre-Filter (PF) for application in the said invention whole house water filter as shown in FIG. 1b.

As regards FIG. 11a, in use water (WI) is flowed into port (IN), enters the Perforated Tube (PT) and flows outward through the Bag or Ceramic Filter (B/CF), including a Filter Material (FM) present therein, and then flows through Perforated Cylinder (PC) and out of Port (OUT) as water flow (WO). As regards FIG. 11b, the Pre-Filter (PF) is applied to receive water (WI) which is flowed into port (IN). Said water (WI) flows through said Pre-Filter (PF) centrally into said Perforated Tube (PT), and then continues to flow as described with respect to FIG. 1a. Note that the bottom of the Perforated Tube (PT) is fitted with a termination Cap (C).

NOTE, while in FIG. 11b some initial water flow is directed inwardly toward the Perforated Tube (PT), the majority of water flow in both the FIG. 11a and 11b systems is outward. That is from a small area toward a large area. This approach minimizes the development of back-pressure, which is undesirable in filters which provide water to a house as it reduces water pressure in said house.

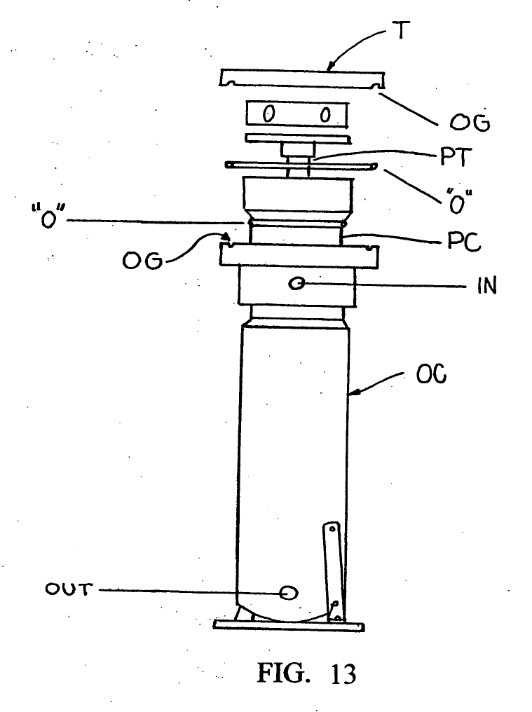

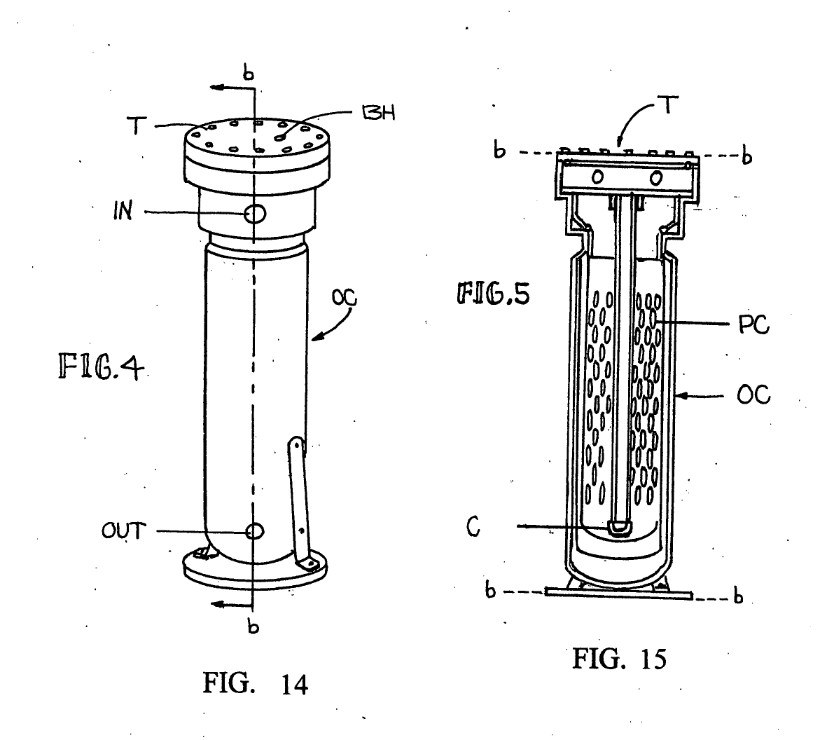

FIG. 13 shows a partially assembled side elevational view of the a realization of a presently disclosed invention system, and FIG. 14 shows an assembled view of the exterior of the presently disclosed invention whole house water filter system. Shown are the Outer Cylinder (OC) and a Top (T) at the upper portion thereof, a portion of a Perforated Tube (PT), In the outer Cylinder are shown the Input (IN) and Output (OUT) Ports. In use, the Perforated Input Tube projects into a Bag or Ceramic Filter (B/CF) which is secured within an Inner Cylinder by a Perforated Cylinder (PC). Further, an “O” ring, or functional equivalent, is sandwiched between said Top and the top of the Outer Cylinder in “0” Ring Grooves (OG). When the Top is secured in place, an input of the Perforated Input Tube is positioned to receive water from the Inlet Port (IN) of the Outer Cylinder (OC). In operation, water is entered to the Inlet Port (IN), and passes through the Perforated Input Tube (PT), through the Filler Material and Bag or Ceramic Filter (B/CF), then through the Perforated Cylinder (PC), and out of the Outlet Port (OUT). The Bag and Filler Material therein, or Ceramic Filter (B/CF) serves to trap particulate and other matter input to the Whole House Filter. FIG. 12a shows the general shape of a Bag or Ceramic Filter (B/CF), including indication of a Central Hole (CH) into which a Perforated Tube (PT) is inserted. Note that another feature of a preferred embodiment is that the Bag and Filler Material or Ceramic Filter (B/CF) is sequestered in an easily changed one piece system. The active portion of said Bag and Filler Material or Ceramic Filter (B/CF) is caused to be present in the annular space between the Central Hole (CH) and the Outer Surface (OS) thereof. This makes changing Filler Material (FM) or Ceramic, when it is spent, a very easy task. FIG. 12b generally shows a Pre-Filter (PF), which is typically of a pleated construction.

FIGS. 12d1 and 12d2 show top and side elevational views of a Ceramic Filter (CF) circumscribed with a Permeable Sheet (PS) inside a Perforated Cylinder (PC). Note that the Perforated Cylinder (PC) provides strength to the contained Ceramic Filter (CF) therewithin and the Permeable Sheet (PS) buffers contact between the Ceramic Filter (CF) and Perforated Cylinder (PC). Without this it is possible that the Ceramic Filter (CF) would “explode” outward when water is entered thereinto centrally so that it flows outward in a manner that keeps any developed back pressure lower than is the case where water flows from the outside inwardly.

FIGS. 12c and 11c show a variation of FIGS. 12b and 11b wherein the Pre-Filter (PF) does not have a Central Hole. This is within the scope of the invention.

It is noted that the Ceramic Filter an be filled with any functional components such Granular Activated Charcoal, and that the Ceramic can have anti-microbial embedded therewithin. Granular Activated Charcoal (ACH) can be provided as a separate module. See FIG. 11c for a demonstrated realization. Further, the Ceramic Filter (CF) can be circumscribed in a buffering material, such as a Permeable polypropelene Sheet (PS) as demonstrated in FIG. 1i. Again, any functional realization as demonstrated in FIGS. 1a-1h can be utilized.

### Oil/Water Filter

First, it is noted that while the third embodiment disclosed directly is well suited to applications in which oil must be removed from water, the disclosed system can be applied to remove other non-water components. For instance, it has been found that the following system can effectively remove particulates such as rust.

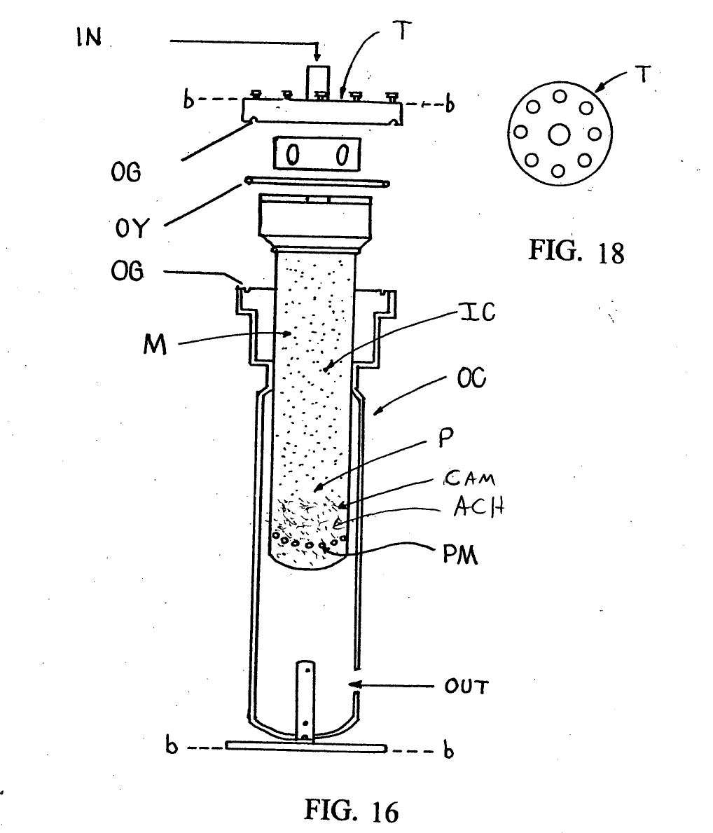

Continuing, FIG. 16 shows a partially constructed side elevational view of the presently disclosed invention system. Note a Top (T), an Inner Cylinder/Colander (IC), and an Outer Cylinder (OC) are present. The Inner Cylinder/Colander positions in the Outer Cylinder, and the Top (T) secures the Inner Cylinder/Colander (IC) in place. There is an “O” ring present between the Top (T) and the upper aspect of the Outer Cylinder (OC). Also shown are “O” ring receiving grooves (OG). Note that the upper portion of the Inner Cylinder/Colander (IC) is shaped to fit in a reception region therefore in the top of the Outer Cylinder (CO), and that when the Top (T) is secured to the Outer Cylinder (C), as shown in FIG. 17, said top of the Inner Cylinder/Colander (IC) is secured in place.

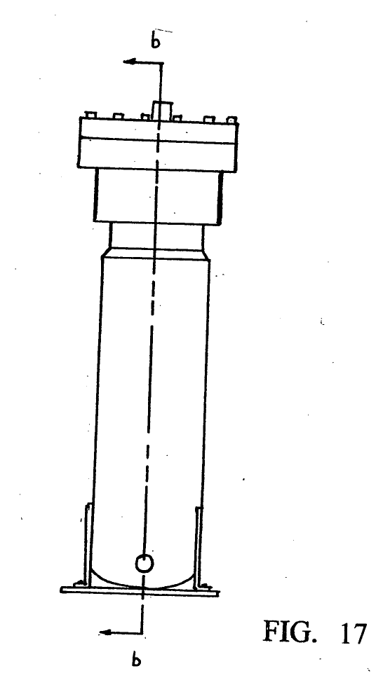

Note also the indication of a mixture (M) of Polypropylene and Plastic Beads in the upper approximately ⅔ of the Inner Cylinder/Colander, and Polypropylene (P) in the lower approximately ⅓ thereof, and Permeable Means (PM) at the bottom thereof. The plastic beads are typically ⅛ to ¼ inch in diameter but can be any functional shape and size. FIG. 17 shows the system with the Top secured to the Outer Cylinder (OC), and FIG. 18 shows a Top view of the Top (T). FIG. 16 indicates that the preferred location in said system for the ceramic with embedded anti-microbial (CAM), (eg. can be KDF), and granular activated charcoal (ACH) is in the lower region of said Inner Cylinder/Colander where water exits at the Permeable Means (PM). The approach to providing the anti-microbial embedded therewithin (CAM), (eg. KDF), and granular activated charcoal (ACH) thereat will typically be similar to that demonstrated in FIG. 1b or 1c. Typically the granular activated charcoal (ACH) will be located adjacent thereto, and the ceramic with anti-microbial embedded therewithin (CAM) will be positioned just thereabove.

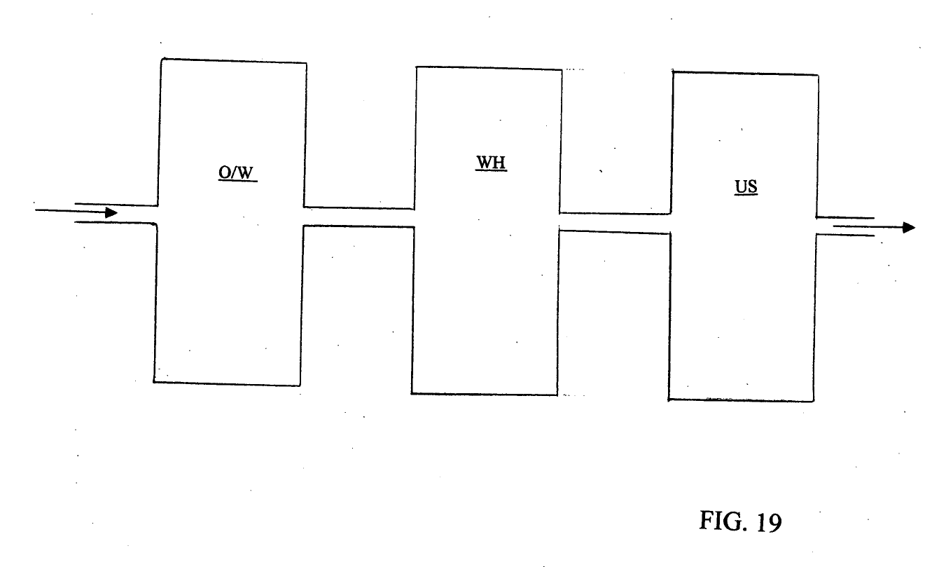

It is also to be understood that, as demonstrated in FIG. 19, a system comprising a sequential combination of a non-water component/water, (eg. oil/water) separator filter (O/W) as shown in FIGS. 16-18, and a whole house filter (WH) as shown in FIGS. 11a-15, can be fashioned into a single sequential system, which single sequential system might also comprise a local filter such as a ¼ turn under the sink water filter (US) as shown in FIGS. 2a-10e. Such a sequence would allow input of water mixed with such as oil or some other non-water component, and the outputting very high quality potable water. Other sequential and/or merged, (eg. two systems combined into one), combinations of the identified filters as disclosed in FIGS. 2a-10e, 11a-15 and 16-18 are also possible.

It is to be understood that while terminology such as Local Filter, Oil/Water Separator and Whole House Filter has been used in this Specification, this is not to be taken to limiting of applications in which said described systems can be applied. For instance, the oil/water separator can be applied to separate other non-water component(s), (eg. rust), from water, and the whole house system can be applied to any structure into which is entered water via a source into an internal plumbing system. Further, while the oil/water and whole house separator systems are typically, because of size, floor mounted, neither is this a limitation.

Finally, it is to be understood that combinations of elements described with respect to one embodiment disclosed in this Specification which can be functionally applied in another embodiment are to be considered as disclosed for application in said other embodiment. That is, for instance, discussion of filter packing material with respect to the embodiment shown in FIGS. 2a-10f2 might be applied in the embodiment shown in FIGS. 11a-15.

Having hereby disclosed the subject matter of the present invention, it should be obvious that many modifications, substitutions, and variations of the said invention are possible in view of the teachings. It is therefore to be understood that the invention may be practiced other than as specifically described, and should be limited in its breadth and scope only by the Claims.

I claim:

1. A water filter system for providing potable water comprising a combination of a ceramic with anti-microbial embedded therewithin, and granular activated charcoal, in functional combination with means for entering, further filtering and exiting water.
Local

2. A water filter system as in claim 1 which is further characterized as being comprised of a combination manifold and valve system to which a filter module removably attaches, said combination manifold and valve system being constructed such that when the manifold is operated to allow affixing a filter module the valve(s) in the manifold are caused to be closed, and when the manifold is operated to securely affix a filter module thereto, the valve(s) in the manifold are caused to be open, said system being characterized in that a single lever which rotates no more than ¼ turn, completely and substantially simultaneously controls both the valves and filter module mounting.

3. A water filter system as in claim 1 which is further characterized as being comprised of a combination manifold and valve system to which a filter module removably attaches and is held in place by means for securing said filter module, said combination manifold and valve system comprising a manifold with two ports to which fluid carrying pipes affix, each of said ports having fluid carrying piping projecting therefrom into a filter module which is secured in place on said manifold, by said means for securing said filter module,
said combination manifold and valve system having affixed thereto means simultaneously operating said valves and means for securing said filter module to said manifold, such that when a filter module is secured in place on said manifold by said means for securing said filter module, said valves are open, and when said filter module is not secured in place on said manifold, said valves are closed.

4. A water filter system as in claim 3 in which the mechanism for controlling the securing of said filter module to said manifold is a single lever of a cantered element which is rotatable affixed to the top of said manifold as it is viewed in side elevation, such that when said lever of said cantered element is rotated in one direction the means for securing said filter module are caused to rise, and when said single lever of said cantered element is rotated in the opposite direction said means for securing said filter module are caused to lower.

5. A water filter system as in claim 3 in which said filter module has a lip at an upper aspect thereof, and said means for securing said filter module have hook-like structures which catch said lip, said means for securing said filter module additionally having an elongated slit therein into which projects a rod which is secured stationary with respect to said manifold.

6. A water filter system as in claim 4 in which said filter module has a lip at an upper aspect thereof, and said means for securing said filter module have hook-like structures which catch said lip, said means for securing said filter module additionally having an elongated slit therein into which projects a rod which is secured stationary with respect to said manifold.

7. A water filter system as in claim 1 which is further characterized as being comprised of a combination manifold and valve system comprising:
a central structural element which has a substantially closed top and sides, said sides having first and second openings therein, each of which is suitable for attaching thereto a fluid carrying pipe, said central structural element having therewithin a substantially circular inner cavity;
there being, during use, a filter module comprising filter media therewithin, secured to the lower extent of said central structural element as viewed in side elevation;
present in said substantially circular inner cavity there being snuggly present a rotatable structural element having a top and a side wall, said rotatable structural element having first and second openings in said wall, which openings are functionally projected inwardly such that fluid entered into one thereof passes through said filter module which is affixed to the lower aspect of said combination manifold and valve system and out of the other thereof;
said first and second openings in said central structural element and said first and second openings in said rotatable structural element wall being arranged with respect to one another such that when the first of the openings in said central structural element and the first of said openings in said rotatable structural element wall are aligned by relative rotation therebetween, then simultaneously so are the second openings in the central structural element and said second opening is said rotatable structural element wall;
there being a rotatably mounted single lever of said cantered element at the top of said central structural element, and there being means for securing said filter module slidably affixed to the sides of said central structural element, said cantered element and means for securing said filter module being functionally interrelated such that causing said single lever of said cantered element to rotate about a substantially vertically oriented axis causes said means for securing said filter module to slide with respect to said central structural element;
said means for securing said filter module having hook-like structures at lower aspects thereof and a slit shaped opening thereabove, into which slit shaped opening projects a rod which is secured stationary with respect to said central structural element;
said combination manifold and valve system filter module further comprising a lip at an upper extent thereof, which hook-like structures are of a shape to catch.

8. A water filter system as in claim 6 in which said slit shaped opening is elongated and oriented such that its elongated dimension projects substantially vertically, as viewed in side elevation.

9. A water filter system as in claim 7 in which said slit shaped opening is elongated and oriented such that its elongated dimension projects at an angle between vertical and horizontal. as viewed in side elevation.

10. A method of filtering fluid comprising the steps of:
a) providing a water filter system for providing potable water comprising a combination of a ceramic with anti-microbial embedded therewithin, and granular activated charcoal, in functional combination with means for entering, additional filtering and exiting water, said water filter system being further characterized by comprising a combination manifold and valve system comprising:
a central structural element which has substantially closed top and sides, said sides having first and second openings therein, each of which is suitable for attaching thereto a fluid carrying pipe, said central structural element having therewithin a substantially circular inner cavity;
there being, during use, a filter module comprising filter media therewithin, secured to the lower extent of said outer cover;
present in said substantially circular inner cavity there being snuggly present a rotatable structural element having a top and wall, said rotatable structural element having first and second openings in said wall, which openings are functionally projected inwardly such that fluid entered into one thereof passes through said filter module which is affixed to the lower aspect of said combination manifold and valve system and out of the other thereof;
said first and second openings in said central structural element and said first and second openings in said rotatable structural element wall being arranged with respect to one another such that when the first of the openings in said central structural element and the first of said openings in said rotatable structural element wall are aligned by relative rotation therebetween, then simultaneously so are the second openings in the central structural element and said second opening is said rotatable structural element wall;
there being a rotatably mounted single lever of a cantered element at the top of said central structural element, and there being means for securing said filter module slidably affixed to the sides of said central structural element, said means for securing said filter module and said central structural element being functionally interrelated such that causing said single lever of said cantered element to rotate about a substantially vertical axis, causes said means for securing said filter module to slide with respect to said central structural element;
said means for securing said filter module having hook-like structures at lower aspects thereof and said filter module further comprising a lip at an upper extent thereof, which. hook-like structures are of a shape to catch said lip;
b) with fluid pressure absent affixing fluid carrying pipes to said first and second openings of said outer cover,
rotating said rotatably mounted single lever of said cantered element at the top of said central structural element so that the first and second holes in said central structural element and said first and second holes in said rotatable structural element wall are not aligned and so said means for securing said filter module having hook-like structures at lower aspects thereof are lowered;
c) entering a filter module such that the lip at said upper extent thereof is grasped by said hook-like structures of said means for securing said filter module;
d) rotating said rotatably mounted single lever of said cantered element at the top of said outer cover so that the first and second holes in said central structural element and said first and second holes in said rotatable structural element wall are aligned and so said means for securing said filter module having hook-like structures at lower aspects thereof are raised to secure said filter module to said combination manifold and valve system; and
e) pressurizing said fluid in said fluid carrying pipes which are affixed to said first and second openings of said central structural element.

11. A method of filtering fluid as in claim 10, which further comprises the steps of:
f) rotating said rotatably mounted single lever of said cantered element at the top of said central structural element so that the first and second holes in said central structural element and said first and second holes in said rotatable structural element wall are not aligned and so said means for securing said filter module having hook-like structures at lower aspects thereof are lowered;
g) removing said filter module and replacing it with a new filter module or replacing the filtering media therein, such that the upper lip of said new filter module or filter module with replaced filtering media therein is grasped by said hook-like structures of said means for securing said filter module; and
h) rotating said rotatably mounted single lever of said cantered element at the top of said central structural element so that the first and second holes in said central structural element and said first and second holes in said rotatable structural element wall are aligned and so said means for securing said filter module having hook-like structures at lower aspects thereof are raised to secure said filter module to said combination manifold and valve system.

12. A method of filtering fluid as in claim 11, in which step g involves replacing filtering media inside the filter module, and in which said filter module comprises, as viewed in side elevation, receptors in an outer covering thereof, each receptor having a vertical and a horizontal section such that each forms an “L” shape; said filter module further comprising a filter lid which attaches to said filter module outer covering by way of sliding nibs on said filter lid into the vertical portions of said receptors on said filter module outer covering, and then causing a slight rotation motion of filter lid so that nibs are positioned in the horizontal portions of said receptor portions, and in which the step of replacing said filtering media comprises:
g1) rotating said filter lid so that said nibs thereon are in the vertical sections of the receptors in the filter module;
g2) removing said filter lid from said filter module outer covering by moving it in a direction defined by the locus of said vertical portions of said receptors;
g3) removing old filtering media present inside said outer covering of said filter module and placing new filtering media thereinto;
g4) positioning said filter lid such that nibs thereon align with vertical portions of the receptors in said filter module and causing said filter lid to move toward said filter module in a direction defined by the locus of said vertical portions of said receptors;
g5) causing said filter lid to rotate so that the nibs thereon are caused to be placed Into the horizontally oriented portions of said “L” shaped receptors.
Whole House

13. A water filter system as in claim 1 which does not develop significant back pressure to water entered thereinto, and further comprises:
an outer cylinder having input and output ports present thereon for entering and exiting water, said outer cylinder being substantially closed on the bottom and sides, and having means for securing a top thereto;
a top;
a perforated input tube functionally continuous with said input port of said outer cylinder;
a bag containing filler material or ceramic filter into which said perforated input tube centrally projects; and
a perforated cylinder which surrounds said bag or ceramic filter;
such that in use said top is secured to said outer cylinder and water is entered to said input port, then passes through said perforated tube, outwardly through said bag or ceramic filter and said perforated cylinder, before exiting through said output port in said outer cylinder.

14. A water filter as in claim 13, wherein the said bag or ceramic filter is an easily changed one piece system.

15. A water filter as in claim 13, which comprises a ceramic filter having silver embedded in the ceramic, the purpose thereof being to prevent captured bacteria from breeding or growing therein as a self sanitizing agent.

16. A method of removing particulate and other matter from water comprising the steps of:
a) providing a water filter system for providing potable water comprising a combination of a ceramic embedded anti-microbial embedded therewithin, and granular activated charcoal, in functional combination with means for entering, additional filtering and exiting water, which water filter system does not develop significant back pressure to water entered thereinto, said water filter system further comprising:
an outer cylinder having input and output port present thereon for entering an exiting water, said outer cylinder being substantially closed on the bottom and sides, and having means for securing a top thereto;
a top;
a perforated tube functionally continuous with said input port of said outer cylinder;
a bag filled with filler material or ceramic filter into which said perforated input tube centrally project; and
a perforated cylinder which surrounds said bag or ceramic filter;
such that in use said top is secured to said outer cylinder and water is entered to said input port, then passes outwardly through said perforated tube, then through said bag or ceramic filter and said perforated cylinder before exiting through said output port in said outer cylinder;
b) connecting said input port of said water filter to a source of water, and connecting said output port to the water input system of a house or the like;
such that in use water containing particulate and other matter is caused to flow through said water filter such that said particulate and other matter is substantially removed, followed by said water with the particulate and other matter substantially removed entering said house.

17. A method as in claim 16, wherein the step of providing a bag containing filler material or ceramic filter containing filler material comprises providing a one piece system.

18. A method as in claim 17 which further comprises the step of removing said top from said outer cylinder, easily removing said bag containing filler material or ceramic filter one piece system, and replacing it with another one piece bag containing filler material or ceramic filter system, followed by re-securing the top to the outer cylinder.

19. A water filter system as in claim 1 which does not develop significant back pressure to water entered thereinto, said water filter system further comprising:
an outer cylinder having input and output port present thereon for entering and exiting water, said outer cylinder being substantially closed on the bottom and sides, and having means for securing a top thereto;
a top;
a perforated input tube functionally continuous with said input port of said outer cylinder;
a bag containing filler material or ceramic filter into which said perforated input tube centrally projects; and
a perforated cylinder which surrounds said bag or ceramic filter;
such that in use said top is secured to said outer cylinder and water is entered to said input port, then passes outwardly through said perforated tube, through said bag or ceramic filter, and said perforated cylinder, before exiting through said output port in said outer cylinder;
said water filter being distinguished in that present between said input port and said perforated tube is present a pre-filter oriented such that water entered into said input port passes therethrough inwardly toward said perforated tube.

20. A water filter as in claim 19, wherein the said bag or ceramic filter is an easily changed one piece system.

21. A water filter as in claim 19, which comprises a ceramic filter having silver embedded in the ceramic, the purpose thereof being to prevent captured bacteria from breeding or growing therein as a self sanitizing agent.

22. A method of removing particulate and other matter from water comprising the steps of:
a) providing a water filter system for providing potable water comprising a combination of a ceramic with anti-microbial embedded therewithin, and granular activated charcoal, in functional combination with means for entering, additional filtering and exiting water, which water filter system does not develop significant back pressure to water entered thereinto, said water filter system further comprising:
an outer cylinder having input and output port present thereon for entering an exiting water, said outer cylinder being substantially closed on the bottom and sides, and having means for securing a top thereto;
a top;
a perforated tube functionally continuous with said input port of said outer cylinder;
a bag filled with filler material or ceramic filter into which said perforated input tube centrally project; and
a perforated cylinder which surrounds said bag or ceramic filter;
such that in use said top is secured to said outer cylinder and water is entered to said input port, then passes outwardly through said perforated tube, then through said bag or ceramic filter and said perforated cylinder before exiting through said output port in said outer cylinder;
said water filter being distinguished in that present between said input port and said perforated tube is present a pre-filter oriented such that water entered into said input port passes therethrough inwardly toward said perforated tube;
b) connecting said input port of said water filter to a source of water, and connecting said output port to the water input system of a house or the like;
such that in use water containing particulate and other matter is caused to flow through said water filter such that said particulate and other matter is substantially removed, followed by said water with the particulate and other matter substantially removed entering said house.

23. A method as in claim 22, wherein the step of providing a bag containing filler material or ceramic filter containing filler material comprises providing a one piece system.

24. A method as in claim 23 which further comprises the step of removing said top from said outer cylinder, easily removing said bag containing filler material or ceramic filter one piece system, and replacing it with another one piece bag containing filler material or ceramic filter system, followed by re-securing the top to the outer cylinder.

25. A water filter as in claim 13 which is floor mounted.

26. A water filter as in claim 13 which is applied to process water entered to a whole house.

27. A method as in claim 16 wherein the step of providing a water filter involves mounting it to a floor.

28. A method as in claim 16 wherein said water filter is applied to process water entered to a whole house.

29. A method as in claim 22 wherein the step of providing a water filter involves mounting it to a floor.

30. A method as in claim 22 wherein said water filter is applied to process water entered to a whole house.
Oil/Water

31. A water filter system as in claim 1 which is a filter system for separating oil from water and further comprises:
an outer cylinder having input and output means present thereon for entering a mixture of water and oil and exiting water, said outer cylinder being closed on the sides and on the lower extent thereof, said outer cylinder having means for securing a top thereto;
a top;
an inner cylinder/colander which is filled with a mixture of polypropylene and plastic beads in the upper majority thereof, and polypropylene in the lower minority thereof, and permeable means at the bottom thereof;
such that in use a said top is secured to said outer cylinder and a mixture of oil and water is entered to the input means, flows through said mixture of polypropylene and plastic beads and polypropylene, then through said permeable means at the bottom of the Inner cylinder/colander before water exits through said output means of the outer cylinder.

32. A filter and in claim 31, wherein the terminology “upper majority” of the cylinder/colander represents approximately ⅔ of the total volume thereof, and the terminology “lower minority” of the cylinder/colander represents approximately ⅓ of the total volume thereof.

33. A method of separating oil from water comprising:
a) providing water filter system for providing potable water comprising a combination of a ceramic with anti-microbial embedded therewithin, and granular activated charcoal, in functional combination with means for entering, additional filtering and exiting water said system comprising a filter for separating oil from water, and further comprising:
an outer cylinder having input and output means present thereon for entering a mixture of water and oil and exiting water, said outer cylinder being closed on the sides and on the bottom thereof, said outer cylinder having means for securing a top thereto;
a top;
an inner cylinder/colander which is filled with a mixture of polypropylene and plastic beads in the upper majority thereof, and polypropylene in the lower minority thereof, and permeable means at the bottom thereof;
such that in use a said top is secured to said outer cylinder and a mixture of oil and water is entered to the input means, flows through said mixture of polypropylene and plastic beads and polypropylene, and through said permeable means at the bottom of the inner cylinder/colander before water exits through said output means of the outer cylinder;
b) entering a mixture of oil and water to the input means and collecting water from the output means.

34. A method as in claim 33, in which the mixture of oil and water is entered in a pulsed manner.

35. A water filter system as in claim 1 which comprises a filter for separating at least one additional component from water, said water filter system further comprising:
an outer cylinder having input and output means present thereon for entering a mixture of water and at least one additional component and exiting water, said outer cylinder being closed on the sides and on the lower extent thereof, said outer cylinder having means for securing a top thereto;
a top;
an inner cylinder/colander which is filled with a mixture of polypropylene and plastic beads in the upper majority thereof, and polypropylene in the lower minority thereof, and permeable means at the bottom thereof;
such that in use a said top is secured to said outer cylinder and a mixture of said at least one additional component and water is entered to the input means, flows through said mixture of polypropylene and plastic beads and polypropylene, then through said permeable means at the bottom of the inner cylinder/colander before water exits through said output means of the outer cylinder.

36. A filter and in claim 35, wherein the terminology “upper majority” of the cylinder/colander represents approximately ⅔ of the total volume thereof, and the terminology “lower minority” of the cylinder/colander represents approximately ⅓ of the total volume thereof.

37. A method of separating at least one additional component from water comprising:
a) providing water filter system for providing potable water comprising a combination of a ceramic with anti-microbial embedded therewithin, and granular activated charcoal, in functional combination with means for entering, additional filtering and exiting water, said water filter further comprising a filter for separating at least one additional component from water comprising an outer cylinder having input and output means present thereon for entering a mixture of water and at least one additional component and exiting water, said outer cylinder being closed on the sides and on the bottom thereof,
said outer cylinder having means for securing a top thereto;
a top;
an inner cylinder/colander which is filled with a mixture of polypropylene and plastic beads in the upper majority thereof, and polypropylene in the lower minority thereof, and permeable means at the bottom thereof;
such that in use a said top is secured to said outer cylinder and a mixture of at least one additional component and water is entered to the input means, flows through said mixture of polypropylene and plastic beads and polypropylene, and through said permeable means at the bottom of the inner cylinder/colander before water exits through said output means of the outer cylinder;
b) entering a mixture of said at least one additional component and water to the input means and collecting water from the output means.

38. A method as in claim 37, in which the mixture of said at least one additional component and water is entered in a pulsed manner.

39. A method as in claim 38, in which the at least one additional component is oil.
New
Oil/Water

40. A water filter system which comprises a filter for separating at least one additional component from water, said water filter system further comprising:
an outer cylinder having input and output means present thereon for entering a mixture of water and at least one additional component and exiting water, respectively, said outer cylinder being closed on the sides and on the lower extent thereof, said outer cylinder having means for securing a top thereto;
a top;
an inner cylinder/colander which is filled with polypropylene and plastic beads distributed in a manner selection selected from the group consisting of:
said plastic beads and polypropylene are randomly distributed in said inner cylinder/colander;
said plastic beads and polypropylene and are uniformly distributed in said inner cylinder/colander;
said plastic beads polypropylene and are distributed in said inner cylinder/colander such that the relative concentration of plastic beads is higher at an upper extent thereof and the relative concentration of polypropelene is higher at the lower extent thereof;
said plastic beads polypropylene and are distributed in said inner cylinder/colander such that the relative concentration of plastic beads is substantially 100% at an upper extent thereof and the relative concentration of polypropelene is higher at the lower extent thereof, but not 100%;
said plastic beads polypropylene and are distributed in said inner cylinder/colander such that the relative concentration of plastic beads is substantially 100% at an upper extent thereof and the relative concentration of polypropelene is higher at the lower extent thereof is 100%;
inner cylinder/colander further having permeable means at the bottom thereof;
such that in use a said top is secured to said outer cylinder and a mixture of said at least one additional component and water is entered to the input means, flows through said mixture of polypropylene and plastic beads and polypropylene, then through said permeable means at the bottom of the inner cylinder/colander before water exits through said output means of the outer cylinder.

41. A water filter system as in claim 40, which further comprises, in said inner cylinder/colander, additional material comprising at least one selection from the group consisting:
anti-microbial material;
activated granular charcoal;
a mixture of anti-microbial material and activated granular charcoal;
in sequence, anti-microbial material and activated granular charcoal;
in sequence, activated granular charcoal and anti-microbial material.

42. A water filter system as in claim 41, in which said at least one additional treatment material is located in proximity to said permeable means of said cylinder/colander.

43. A water filter system as in claim 40, in which the plastic beads are described as a selection for the group:
substantially ⅛ to ¼ inch in diameter; and
of any functional shape and size.

44. A water filter system as in claim 40, which further comprises a ceramic filter which is present inside said inner cylinder/colander, and within which ceramic filter are present said polypropelene and plastic beads.
Whole House

45. A water filter system which does not develop significant back pressure to water entered thereinto comprising:
an outer cylinder having input and output ports present thereon for entering and exiting water, said outer cylinder being substantially closed on the bottom and sides, and having means for securing a top thereto;
a top;
a perforated input tube functionally continuous with said input port of said outer cylinder;
a ceramic filter comprising a space therewithin and into which said perforated input tube substantially centrally projects, there being activated granular charcoal within said space surrounding and said perforated input tube; and
a perforated cylinder which surrounds said ceramic filter;
such that in use said top is secured to said outer cylinder and water is entered to said input port, then passes through said perforated tube, outwardly through said granular activated charcoal and ceramic filter and said perforated cylinder, before exiting through said output port in said outer cylinder.

46. A water filter system as in claim 45, wherein the said ceramic filter is an easily changed one piece system comprising sides and a bottom.

47. A water filter system as in claim 45, which comprises a ceramic filter having anti-microbial embedded in the ceramic, the purpose thereof being to prevent captured bacteria from breeding or growing therein as a self sanitizing agent.

48. A water filter system as in claim 47, in which said anti-microbial embedded in the ceramic is silver.

49. A water filter system as in claim 45, in which the ceramic filter is be circumscribed on at least the outer surface of said sides by permeable means for physically protecting said ceramic, said permeable means being sandwiched between the ceramic filter and inner surface of the perforated cylinder to provide a buffered contact to the strength providing perforated cylinder.
Local

50. A water filter system comprising a combination manifold and valve system comprising:
a central structural element which has a substantially closed top and sides, said sides having first and second openings therein, each of which is suitable for attaching thereto a fluid carrying pipe, said central structural element having therewithin a substantially circular inner cavity;
there being, during use, a filter module secured to the lower extent of said central structural element as viewed in side elevation, said filter module comprising an outer cylinder which contains a ceramic filter having sides and a bottom such that a space is present within said ceramic filter, there being present within said space polypropylene and plastic beads distributed in a manner selection selected from the group consisting of:
said plastic beads and polypropylene are randomly distributed in said ceramic filter;
said plastic beads and polypropylene and are uniformly distributed in said ceramic filter;
said plastic beads polypropylene and are distributed in said ceramic filter such that the relative concentration of plastic beads is higher at an upper extent thereof and the relative concentration of polypropelene is higher at the lower extent thereof;
said plastic beads polypropylene and are distributed in said ceramic filter such that the relative concentration of plastic beads is substantially 100% at an upper extent thereof and the relative concentration of polypropelene is higher at the lower extent thereof, but not 100%;
said plastic beads polypropylene and are distributed in said ceramic filter such that the relative concentration of plastic beads is substantially 100% at an upper extent thereof and the relative concentration of polypropelene is higher at the lower extent thereof is 100%;
said filter module being circumscribed on at least the outer surface of said sides by permeable means for physically protecting said ceramic;
in said substantially circular inner cavity there being snuggly present a rotatable structural element having a top and a side wall, said rotatable structural element having first and second openings in said wall, which openings are functionally projected inwardly such that fluid entered into one thereof passes through said filter module which is affixed to the lower aspect of said combination manifold and valve system and out of the other thereof;
said first and second openings in said central structural element and said first and second openings in said rotatable structural element wall being arranged with respect to one another such that when the first of the openings in said central structural element and the first of said openings in said rotatable structural element wall are aligned by relative rotation therebetween, then simultaneously so are the second openings in the central structural element and said second opening is said rotatable structural element wall;
there being a rotatably mounted single lever of said cantered element at the top of said central structural element, and there being means for securing said filter module slidably affixed to the sides of said central structural element, said cantered element and means for securing said filter module being functionally interrelated such that causing said single lever of said cantered element to rotate about a substantially vertically oriented axis causes said means for securing said filter module to slide with respect to said central structural element;
said means for securing said filter module having hook-like structures at lower aspects thereof and a slit shaped opening thereabove, into which slit shaped opening projects a rod which is secured stationary with respect to said central structural element;
said combination manifold and valve system filter module further comprising a lip at an upper extent thereof, which hook-like structures are of a shape to catch.

51. A water filter system as in claim 50, which further comprises, in said ceramic filter, additional material comprising at least one selection from the group consisting:
anti-microbial material;
activated granular charcoal;
a mixture of anti-microbial material and activated granular charcoal;
in sequence, anti-microbial material and activated granular charcoal;
in sequence, activated granular charcoal and anti-microbial material.

52. A water filter system as in claim 51, in which said at least one additional treatment material is located in proximity to said ceramic filter.

53. A water filter system as in claim 50, in which the plastic beads are substantially ⅛ to ¼ inch in diameter.

54. A water filter system as in claim 50, in which the plastic beads are of any functional shape and size.

55. A water filter system as in claim 50 in which said slit shaped opening is elongated and oriented such that its elongated dimension projects substantially vertically, as viewed in side elevation.

56. A water filter system as in claim 50 in which said slit shaped opening is elongated and oriented such that its elongated dimension projects at an angle between vertical and horizontal. as viewed in side elevation.

57. A water filter system as in claim 50 in which said permeable means for physically protecting said ceramic filter which circumscribes at least the outer surface of said sides thereof, is a polypropelene sheet, said polypropylene sheet being sandwiched between said ceramic filter and the outer cylinder of said filter module.

58. A water filter system as in claim 44 in which said ceramic has a pore size of about 0.9 micron or less.

59. A water filter system as in claim 45 in which said ceramic has a pore size of about 0.9 micron or less.

60. A water filter system as in claim 50 in which said ceramic has a pore size of about 0.9 micron or less.

61. A water filter apparatus comprising a sequence of first and second water filters:
said first water filter system providing means for separating at least one non-water component from water comprising an inner cylinder/colander which is filled with polypropylene and plastic beads distributed in a manner selection selected from the group consisting of:
said plastic beads and polypropylene are randomly distributed in said inner cylinder/colander;
said plastic beads and polypropylene and are uniformly distributed in said inner cylinder/colander;
said plastic beads polypropylene and are distributed in said inner cylinder/colander such that the relative concentration of plastic beads is higher at an upper extent thereof and the relative concentration of polypropelene is higher at the lower extent thereof;
said plastic beads polypropylene and are distributed in said inner cylinder/colander such that the relative concentration of plastic beads is substantially 100% at an upper extent thereof and the relative concentration of polypropelene is higher at the lower extent thereof, but not 100%;
said plastic beads polypropylene and are distributed in said inner cylinder/colander such that the relative concentration of plastic beads is substantially 100% at an upper extent thereof and the relative concentration of polypropelene is higher at the lower extent thereof is 100%; and
said second water filter system being constructed to not develop significant back pressure to water entered thereinto from the output of said first water filter system, because water entered thereinto flows radially from a central location therein toward a larger area outer location.

62. A water filter apparatus as in claim 61 in which said first water filter system further comprises, in the inner cylinder/colander thereof, additional material comprising at least one selection from the group consisting:
anti-microbial material;
activated granular charcoal;
a mixture of anti-microbial material and activated granular charcoal;
in sequence, anti-microbial material and activated granular charcoal;
in sequence, activated granular charcoal and anti-microbial material.

63. A water filter apparatus as in claim 61 which further comprises a third water filter system which provides a final stage of water filtering to water entered thereinto from the output of said second water filter and provide as output, high quality potable water.

64. A water filter apparatus as in claim 63 in which said third water filter system is further characterized as being comprised of a combination manifold and valve system to which a filter module removably attaches, said combination manifold and valve system being constructed such that when the manifold is operated to allow affixing a filter module the valve(s) in the manifold are caused to be closed, and when the manifold is operated to securely affix a filter module thereto, the valve(s) in the manifold are caused to be open, said system being characterized in that a single lever which rotates no more than ¼ turn, completely and substantially simultaneously controls both the valves and filter module mounting.

65. A water filter apparatus as in claim 63 in which said second water filter system is further characterized as being comprised of an outer cylinder having input and output ports present thereon for entering and exiting water, said outer cylinder being substantially closed on the bottom and sides, and having means for securing a top thereto;
a top;
a perforated input tube functionally continuous with said input port of said outer cylinder;
a bag or ceramic filter comprising a space therewithin and into which said perforated input tube substantially centrally projects, there being activated-granular charcoal within said space surrounding and said perforated input tube; and
a perforated cylinder which surrounds said bag or ceramic filter;
such that in use said top is secured to said outer cylinder and water is entered to said input port, then passes through said perforated tube, outwardly through said granular activated charcoal and ceramic filter and said perforated cylinder, before exiting through said output port in said outer cylinder.
